(19) United States
(12) Patent Application Publication
(10) Pub. No.: US 2016/0203007 A1
(43) Pub. Date: Jul. 14, 2016

(54) METHOD FOR CONTROL PROCEDURE, RECORDING MEDIUM, AND APPARATUS FOR CONTROL PROCEDURE

(71) Applicant: FUJITSU LIMITED, Kawasaki-shi (JP)

(72) Inventor: Masaru UENO, Kawasaki (JP)

(73) Assignee: FUJITSU LIMITED, Kawasaki-shi (JP)

(21) Appl. No.: 14/948,828

(22) Filed: Nov. 23, 2015

(30) Foreign Application Priority Data
Jan. 8, 2015 (JP) 2015-002145

(51) Int. Cl. G06F 9/445; H04L 29/08; G06F 17/30

(52) U.S. Cl. CPC G06F 9/44505; G06F 17/30297; H04L 67/1097

(57) ABSTRACT

In a control procedure creation method, a computer acquires changed contents of a state of an information processing system including a plurality of devices, creates, by use of state information on the plurality of devices that is stored in a storage and the received changed contents, state information on the information processing system for each state transition on the basis of possible states of each of the plurality of devices during a transition, in accordance with the changed contents, until the information processing system reaches a changed state, extracts, from the created state information on the information processing system for each state transition, a candidate procedure for controlling the plurality of devices until the information processing system reaches the changed state, on the basis of a set of state transition rules stored in the storage, and identifies, from among the candidate control procedures, a control procedure including the fewest steps.

### CROSS-REFERENCE TO RELATED APPLICATION

This application is based upon and claims the benefit of priority of the prior Japanese Patent Application No. 2015-002145, filed on Jan. 8, 2015, the entire contents of which are incorporated herein by reference.

### FIELD

The embodiments discussed herein are related to a method for control procedure, a recording medium, and an apparatus for control procedure.

### BACKGROUND

There is an information processing system formed by multiple tiers in accordance with the service requirements of a client, for example, three tiers such as a web server tier, an application (APP) server tier, and a database (DB) server tier. The web server tier and the APP server tier are each formed by a plurality of devices. In such an information system, at the time of maintenance of a device or when a failure occurs in the device, the state of the device is switched between a standby state and an active state so that the system as a whole does not stop.

As an example of such a system, there is a system that automatically updates an active module and a standby module without stopping normal operations in a duplexer (for example, Patent Document 1).
Patent Document 1: Japanese Laid-open Patent Publication No. 2008-217201
Patent Document 2: Japanese Laid-open Patent Publication No. 10-143361
Patent Document 3: Japanese Laid-open Patent Publication No. 2000-105750

### SUMMARY

In a control procedure creation method according to an aspect of the present invention, a computer performs the following process. The computer acquires changed contents of a state of an information processing system including a plurality of devices. By use of state information on the plurality of devices that is stored in a storage and the received changed contents, the computer creates state information on the information processing system for each state transition on the basis of possible states of each of the plurality of devices during a transition, in accordance with the changed contents, until the information processing system reaches a changed state. The computer extracts, from the created state information on the information processing system for each state transition, a candidate procedure for controlling the plurality of devices until the information processing system reaches the changed state, on the basis of a set of state transition rules stored in the storage. The computer identifies, from among the candidate control procedures, a control procedure that includes the fewest steps.

The object and advantages of the invention will be realized and attained by means of the elements and combinations particularly pointed out in the claims. The computer extracts

It is to be understood that both the foregoing general description and the following detailed description are exemplary and explanatory and are not restrictive of the invention.

### BRIEF DESCRIPTION OF DRAWINGS

FIG. 1 is a block diagram that illustrates an example of a control procedure creation apparatus according to embodiments of the present invention;

FIG. 2 is a block diagram that illustrates an example of a procedure creation apparatus and a system that is a target for the procedure creation according to the embodiments of the present invention;

FIG. 3 is a table that illustrates an example of an operation for a combination of an old or new version of an application and an old or new version of a DB schema according to the embodiments of the present invention;

FIGS. 4A and 4B illustrate examples of initial state information and terminated state information according to the embodiments of the present invention;

FIG. 5 is a flowchart that illustrates a non-disruption-procedure creation processing flow by use of a state transition graph and a set of transition rules according to the embodiments of the present invention;

FIG. 6 illustrates an example of a system state table according to the embodiments of the present invention;

FIG. 7 illustrates an example of a state transition graph before a set of transition rules is applied according to the embodiments of the present invention;

FIG. 8 is a table that illustrates an example of a set of transition rules according the embodiments of the present invention;

FIG. 9 illustrates a state transition graph when the set of transition rules is applied to the state transition graph of FIG. 7;

FIG. 10 illustrates searching for the shortest transition route from an initial state to a terminated state in a state transition graph to which a set of transition rules is applied and associating each transition with a procedure, according to the embodiments of the present invention;

FIG. 11 illustrates a procedure creation when transition rule 1 “downgrading is prohibited” is replaced with “upgrading is prohibited” according to the embodiments of the present invention;

FIG. 12 is a block diagram that illustrates a cloud system and a user terminal according to a first embodiment of the present invention;

FIGS. 13A to 13D illustrate examples of pieces of information managed by a cloud management mechanism and an example of information transmitted from the user terminal according to the first embodiment;

FIG. 14 illustrates an example of a system state table according to the first embodiment;

FIGS. 15A and 15B illustrate examples of state transition graphs before and after a set of transition rules is applied according to the first embodiment;

FIG. 16 illustrates an example of a transition list according to the first embodiment;

FIG. 17 illustrates an example of a procedure list according the first embodiment;

FIG. 18A is Part 1 of a flowchart for creating a state transition graph according to the first embodiment;

FIG. 18B is Part 2 of a flowchart for creating a state transition graph according to the first embodiment;

FIG. 19 is a flowchart that illustrates a process of determining (S14-6) whether each state transition included in a state transition graph before a set of transition rules satisfies transition rule 1 according to the first embodiment;

FIG. 20 is a flowchart that illustrates a process of determining (S14-6) whether each state transition included in a state transition graph before a set of transition rules satisfies transition rule 2 according to the first embodiment;

FIG. 21 is a flowchart that illustrates a process of determining (S14-6) whether each state transition included in a state transition graph before a set of transition rules satisfies transition rule 3 according to the first embodiment;

FIG. 22 is a flowchart that illustrates in detail a process of searching for a graph route (S15) according to the first embodiment;

FIG. 23 is a flowchart that illustrates in detail a process of associating (S16) each transition with a procedure according to the first embodiment;

FIG. 24 illustrates an initial state and a terminated state of a target system according to a second embodiment of the present invention;

FIG. 25 illustrates a state transition graph according to the second embodiment;

FIG. 26 illustrates an initial state and a terminated state of a target system according to a third embodiment.

FIG. 27 illustrates a state transition graph according to the third embodiment; and

FIG. 28 is a configurative block diagram that illustrates an example of a hardware environment of a computer that executes a program according to the embodiments of the present invention.

### DESCRIPTION OF EMBODIMENTS

When performing a process of updating a function (an application program) of a certain tier in such a multi-tier information processing system, it is possible to update the function while considering non-disruptive operations of the system.

An update of a function may affect a function of another tier, so the order of updating the functions that may be affected also has to be considered. For example, if an information processing system has a fixed configuration, it is possible to create an update procedure in advance.

However, a fixed update procedure is useless because a system configuration changes depending on the usage, and when performing a process of updating a certain function, various current conditions need to be considered in order to create a procedure for updating a function. But it is not possible to dynamically create an update procedure because it is difficult to know characteristics of a function or a relationship for each function.

In one aspect, an object of the present invention is to provide an optimal procedure for controlling an information processing system until the information processing system reaches a changed state when there is a change in the state of the information processing system.

For an information processing system, a standby system and an active system are often used in combination by use of a switching device such as a load balancer (LB). As an example of switching between a standby system and an active system, the following case is assumed.

For example, it is assumed that there is an information processing system that includes one load balancer, two APP servers, and one DB server. Here, one of the two APP servers is used as a standby system and another is used as an active system. When installing a new version of a program in the information processing system, first, an application program (hereinafter referred to as “application”) that runs on the standby APP server is updated to version 2. Next, the setting of the load balancer is changed, and switching is performed between the standby system and the active system. Then, a DB schema is updated to version 2.

In this way, a non-disruptive system in which the system as a whole does not stop is realized.

Regarding such an information processing system, a change in system configuration according to the service requirement of a client has been often made in recent years.

However, it is difficult to determine an update procedure (a command sequence or a sequence of tasks described in natural language) because an update of part of a system affects the operations of the other parts. For example, in a system in which there are a plurality of components of the system such as an APP server, an order of updating servers affects whether the service stops or does not stop when updating these components.

For example, when updating an active application, the time period during which it is not possible to respond to a user occurs. Further, there is a loss of data that is being calculated by the application. In order to avoid such a situation, the setting of a load balancer is changed first, so as to perform switching between a standby system and an active system.

Further, for example, when updating a DB schema without updating an application, there is a possibility that an information processing system does not operate normally because an inconsistency in data format occurs when data is accessed.

Furthermore, an update procedure is different for each system configuration, so an update procedure needs to be determined (and verified) according to the change in system configuration. The reasons for this are that there is a relationship of an order to be satisfied in the update procedure, and also that the way of confirming a current state or the way of updating a server differs according to the type of server (a load balancer, a web server, an APP server, or a DB server).

Therefore, in embodiments of the present invention, a procedure creation technology that determines an operation procedure to be performed at the time of migration of the information processing system having a system configuration that is dynamically changed will be described.

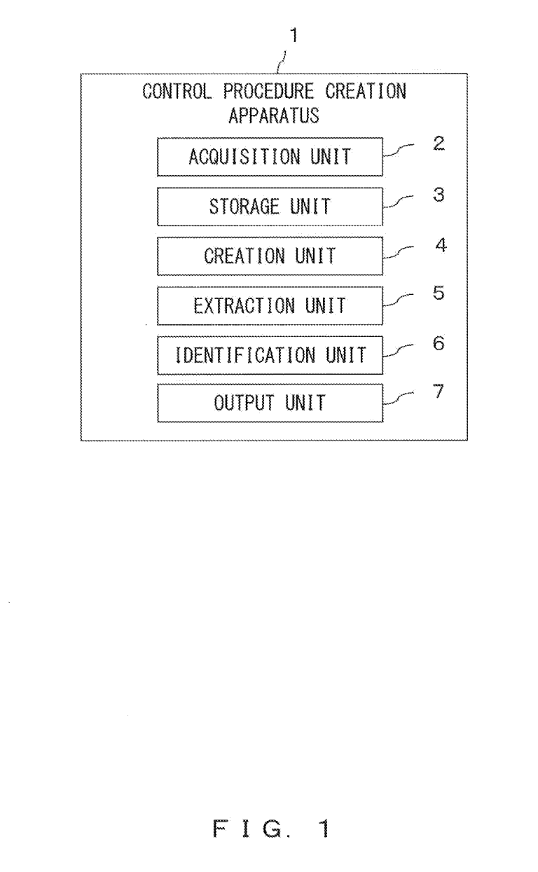

FIG. 1 is a block diagram that illustrates an example of a control procedure creation apparatus according to embodiments of the present invention. A control procedure creation apparatus 1 includes an acquisition unit 2, a storage unit 3, a creation unit 4, an extraction unit 5, and an identification unit 6.

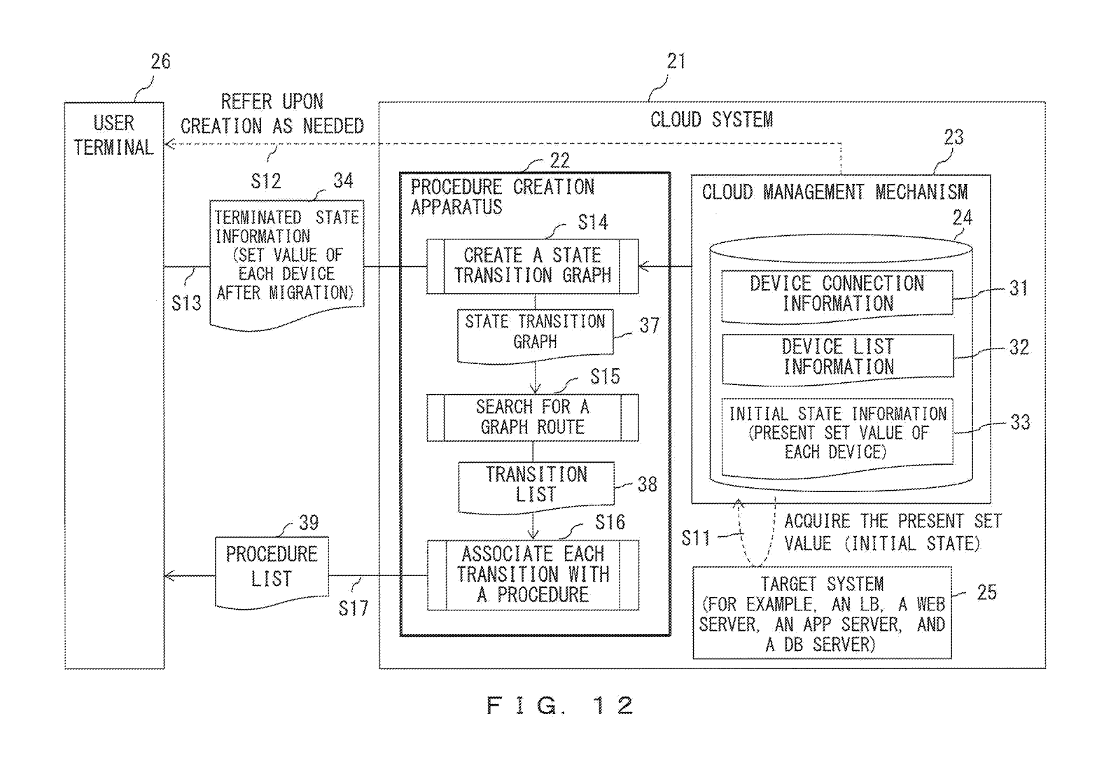

The acquisition unit 2 acquires changed contents of a state of an information processing system that includes a plurality of devices. A CPU 42 (S14 of FIG. 12) that reads terminated state information 34 described below is an example of the acquisition unit 2.

The storage unit 3 stores therein state information on the plurality of devices and a set of state transition rules. A storage 47 described below is an example of the storage unit 3. Initial state information 33 described below is an example of the state information on the plurality of devices. A set of transition rules 14 described below is an example of the set of state transition rules.

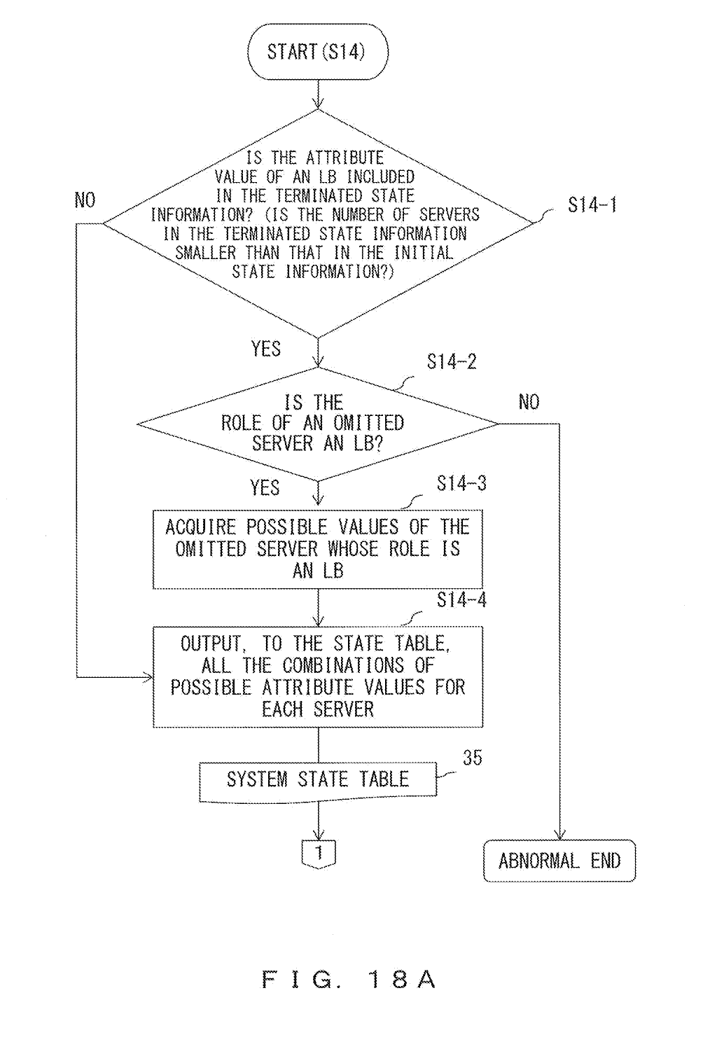

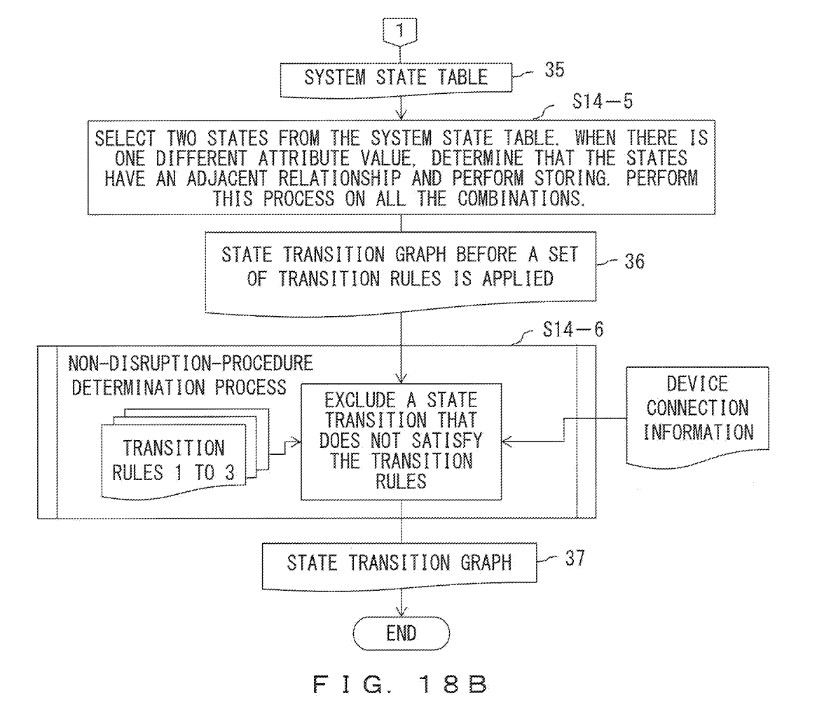

By use of the state information on the plurality of devices and the received changed contents, the creation unit 4 creates state information on the information processing system for each state transition on the basis of possible states of each of the plurality of devices during a transition, in accordance with the changed contents, until the information processing system reaches a changed state. The CPU 42 that performs the process of S14-4 (FIG. 18A) described below is an example of the creation unit 4.

The extraction unit 5 extracts, from the created state information on the information processing system for each state transition, a candidate procedure for controlling the plurality of devices until the information processing system reaches the changed state, on the basis of the set of state transition rules. The CPU 42 that performs the process of S14-6 (FIG. 18B) described below is an example of the extraction unit 5.

The identification unit 6 identifies, from among the candidate control procedures, a control procedure that includes the fewest steps. The CPU 42 that performs the process of S15 (FIG. 12) described below is an example of the identification unit 6.

Such a configuration permits providing of an optimal procedure for controlling an information processing system until the information processing system reaches a changed state when there is a change in the state of the information processing system.

The creation unit 4 acquires two pieces of state information from the state information on the information processing system and compares attribute values that are included in the pieces of state information and whose attributes correspond to each other. As a result of the comparison, the creation unit 4 associates, as state information before and after transition, pieces of state information in pairs that have one different attribute value.

Such a configuration permits a mutual association of pieces of state information in pairs that have an adjacent relationship from among all the possible pieces of state information of the information processing system.

A set of transition rules includes the following three rules. A first transition rule prohibits, from among transitions between associated two pieces of state information, a transition in which a program is downgraded. A second transition rule prohibits, from among the transitions between associated two pieces of state information, a transition when a device whose state has been changed is operating. A third transition rule prohibits, from among the transitions between associated two pieces of state information, a transition when the change in state occurs in a combination of certain versions of programs for which an operation has not been verified between a plurality of devices.

Such a configuration permits selecting of a candidate control procedure by use of a set of transition rules in which the conditions for non-disruptively performing a system migration are formalized for a state transition between two states.

The control procedure creation apparatus 1 further includes an output unit 7. By use of control contents of each of the plurality of devices when a state has been changed, the control contents being stored in a storage, the output unit 7 outputs control procedure information in which each step included in the identified control procedure is associated with control contents of a device corresponding to each of the steps. The CPU 42 that performs the process of S16 (FIG. 12) described below is an example of the output unit 7.

Such a configuration permits providing of a specific control procedure to a user according to the change in the state of an information processing system.

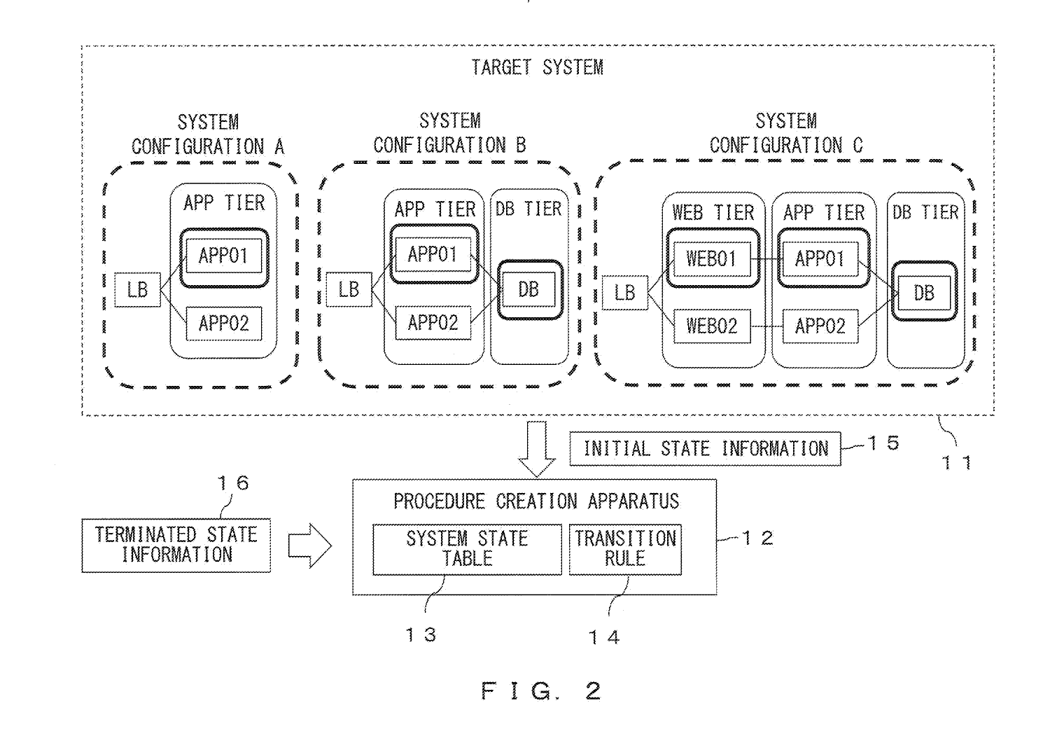

FIG. 2 is a block diagram that illustrates an example of a procedure creation apparatus and a system that is a target for the procedure creation according to the embodiments of the present invention. A target system 11 is an information processing system in which switching between an active server and a standby server can be performed by use of a switching device such as an LB. FIG. 2 represents system configurations A, B, and C as an example of a target system. In FIG. 2, an active system is represented by the bolded border.

For example, in the system configuration A, one LB is connected to two APP servers (APP01 and APP02). Further, switching is performed in the LB so that APP01 is enable as an active system. On the other hand, APP02 is enable as a standby system.

For example, in the system configuration B, one load balancer LB is connected to two APP servers (APP01 and APP02). The two APP servers (APP01 and APP02) are connected to a DB server. Further, switching is performed in the LB so that APP01 and the DB server are enable as an active system. On the other hand, APP02 is enable as a standby system.

Further, for example, in a multi-tier system partitioned by use of an LB (for example, a three tier of web-APP-DB), the number of web servers and the number of APP servers may be two or more each. In this case, the number of web servers and the number of APP servers in the respective tiers may increase to three or more each for load sharing. For example, in the system configuration C, one load balancer LB is connected to two web servers (WEB01 and WEB02). The two web servers are connected to the respective APP servers (APP01 and APP02). The two APP servers (APP01 and APP02) are connected to a DB server. Further, switching is performed in the LB so that WEB01, APP01, and the DB server are enable as an active system. On the other hand, WEB02 and APP02 are enable as a standby system.

In the embodiments, an item that is set to each device, such as a version of a program or DB schema in each server that configures a target system, and a device that is switched to by an LB, is referred to as “attribute”. Further, regarding the item set to each device, a set value or a possible value is referred to as “attribute value”.

A procedure creation apparatus 12 creates a task for a device when performing a non-disruptive system migration. The procedure creation apparatus 12 treats sets of attribute values of all the devices that configure a target system 11 as a state of the system. Further, it is assumed that the task for a device changes (transitions) the target system from a certain state to another state. In this case, an initial state that is a state before migration and a terminated state that is a state after migration are provided. Specifically, the procedure creation apparatus 12 acquires, from the target system 11, an attribute value before migration of each device that is set at present, as initial state information 15. Further, the procedure creation apparatus 12 acquires an attribute value after migration of each device that is input by a user, as terminated state information 16.

In this case, migration refers to a replacement of an old version of a program such as an operating system (OS) or an application that has been installed in a computer with a new version.

Using the initial state information 15 and the terminated state information 16, the procedure creation apparatus 12 creates all the possible states of the target system from the initial state to the terminated state as a system state table 13. Using the set of transition rules 14, the procedure creation apparatus 12 determines, from the system state table 13, an optimal state transition that connects between the initial state and the terminated state, and sequentially outputs the tasks for the devices in the system that are needed for the state transition. This permits determining of a procedure to be performed during migration.

In this case, a task for a server refers to, for example, each operation such as downloading an application, arranging and installing it in a designated location, starting it, and verifying its operation. Further, a procedure refers to a procedure in which the tasks described above are put in a specified order.

A set of transition rules will be described. In order for a system to remain non-disruptive when migration is performed, a checking mechanism to ensure non-disruption is needed in addition to putting tasks for a server in order. For this purpose, the set of transition rules (described below) 14 in which the conditions for a non-disruptive system migration are formalized for a state transition between two states is defined in the embodiments.

Using the set of transition rules 14, the procedure creation apparatus 12 compares specific attribute values before and after transitions from among the states before and after transitions, and determines, to be a prohibited transition, a combination of set values (attribute values) that does not satisfy the set of transition rules 14.

In the embodiments, the procedure creation apparatus 12 manages, for example, a combination of the following set values (i) to (iii) in each device as system state information.

(i) LD: a transfer destination server
(ii) Web server, APP server: a version of an application in a server
(iii) DB server: a version of a DB schema

Further, the following three restrictions to be satisfied in which the conditions for a non-disruptive system migration are formalized are set as the set of transition rules 14.

<Restriction 1> Downgrades of an application and a DB schema are prohibited (if migration is performed, a value indicating a version is larger.). For example, the procedure creation apparatus 12 respectively compares set values (ii) before and after a state transition and set values (iii) before and after the state transition, and determines it to be a prohibited transition when the set value after the transition is smaller.

<Restriction 2> An active server is not updated. In other words, when a version of an application (ii) has been changed before and after a state transition, the transition is prohibited if the server in which the application has been installed is operating. Here, confirming the set value of an LB before the server permits determining whether the server is operating. For example, a cloud management mechanism holds connection relationships between all servers, so an LB before a certain server can be identified by inquiring for that information.

<Restriction 3> In a state after transition, aversion of an APP program of an APP server ((ii)) and a version of a schema of a DB server ((iii)) correspond to each other.

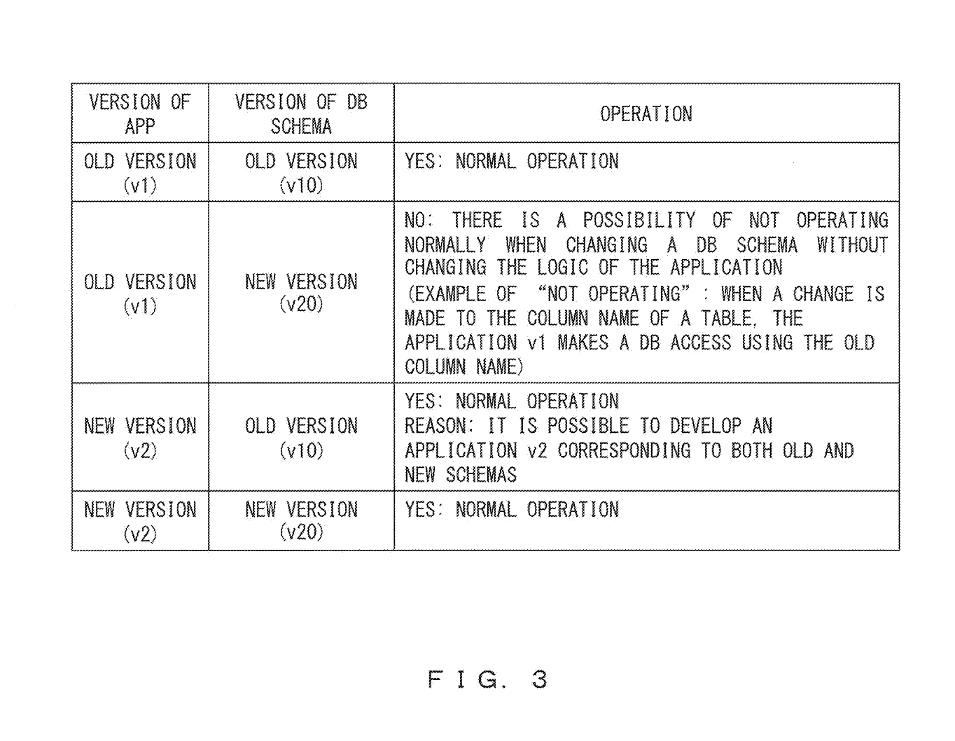

For example, for a combination of an old version of an APP program and a new version of a DB schema, the APP program accesses the DB in a wrong data format, which is an abnormal operation. Thus, when a version of an application in an active APP server ((ii)) and a version of a DB schema ((iii)) do not correspond to each other, the transition is prohibited. This will be described with reference to FIG. 3.

FIG. 3 is a table that illustrates an example of an operation for a combination of an old or new version of an application and an old or new version of a DB schema according to the embodiments of the present invention. When the combination is “an old version of an application and an old version of a DB schema”, “a new version of an application and an old version of a DB schema”, or “a new version of an application and a new version of a DB schema”, a target system operates normally.

On the other hand, there is a possibility that an application does not operate normally when the combination is “an old version of an application and a new version of a DB schema”. For example, when a change is made to the column name of a table as a change in DB schema, the application v1 does not operate normally because it makes a DB access using the column name before the change.

Thus, restriction 3 described above prohibits a transition when a version of an application of an active APP server ((ii)) and a version of a DB schema ((iii)) do not correspond to each other.

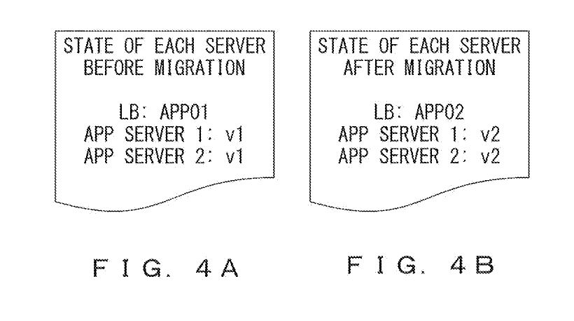

FIGS. 4A and 4B illustrate examples of initial state information and terminated state information according to the embodiments of the present invention. Initial state information 15 represents state information on each server before migration. Terminated state information 16 represents an example of state information on each server after migration.

In FIGS. 4A and 4B, the attribute values of an LB are “APP01” and “APP02”. The attribute values of an APP server are “v1” and “v2”. In this case, v1 represents a version of an application or a DB schema before migration. v2 represents a version of an application or a DB schema after migration.

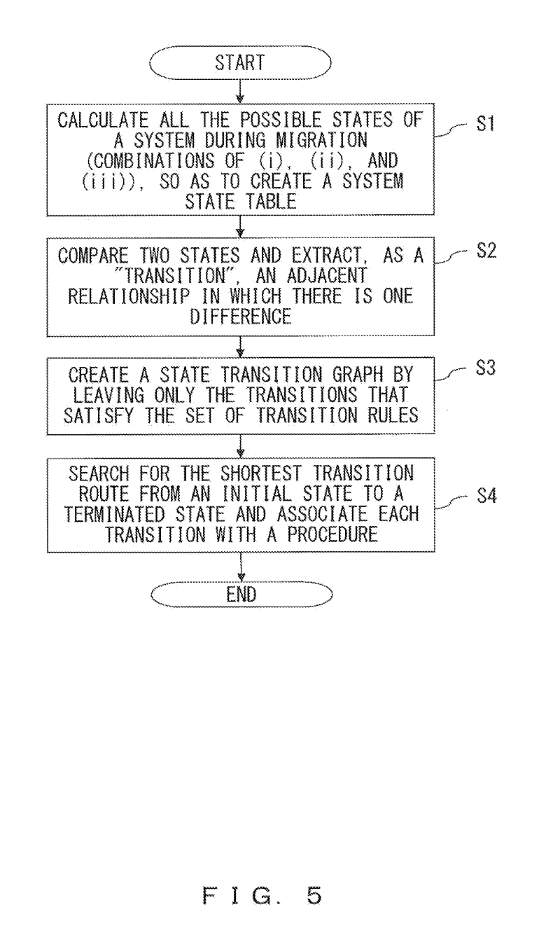

FIG. 5 is a flowchart that illustrates a non-disruption-procedure creation processing flow by use of a state transition graph and a set of transition rules according to the embodiments of the present invention. FIG. 4 will be described below with reference to each of the descriptions of FIGS. 5 to 11. In the embodiments, the system configuration A of FIG. 2 will be used as an example of the target system 11 for convenience of description.

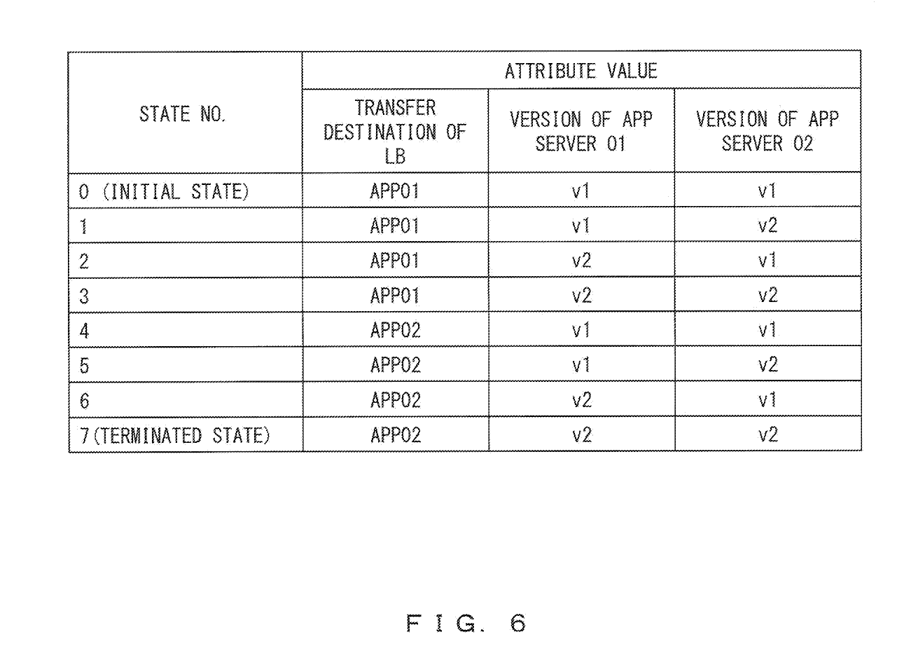

The procedure creation apparatus 12 calculates all the possible states of a target system from the beginning to the termination of a migration (combinations of (i), (ii), and (iii)) on the basis of the initial state information 15 and the terminated state information 16, so as to create a system state table 13 (S1). This will be described by use of FIG. 6.

FIG. 6 illustrates an example of a system state table according to the embodiments of the present invention. In the embodiments, all the combinations of attribute values of all the devices that configure the target system 11 are considered a state of a system. The system state table 13 includes items “STATE” and “ATTRIBUTE VALUE”.

The item “STATE NO.” is information that is provided to uniquely distinguish each state of the target system 11. “ATTRIBUTE VALUE” represents the possible item states of each device in the process of migration. In FIG. 4, there are “TRANSFER DESTINATION OF LB” (an attribute value of an LB), “VERSION NO. OF APP SERVER 01” (an attribute value of an APP server 01), and “VERSION NO. OF APP SERVER 02” (an attribute value of an APP server 02) as an “attribute value”.

There are two attribute values “APP 01” and “APP 02” as an attribute value of an LB. There are two attribute values “v1” and “v2” as an attribute value of APP 01. There are two attribute values “v1” and “v2” as an attribute value of APP 02. Thus, there are 2×2×2=8 combinations of attribute values of the LB, APP 01, and APP 02. In FIG. 6, unique numbers 0 to 7 are provided to the states that are represented by the eight combinations. Here, a combination of attribute values for an initial state (before migration) corresponds to a state “0”. A combination of attribute values for a terminated state (after migration) corresponds to a state “7”. Now return to the description of FIG. 5.

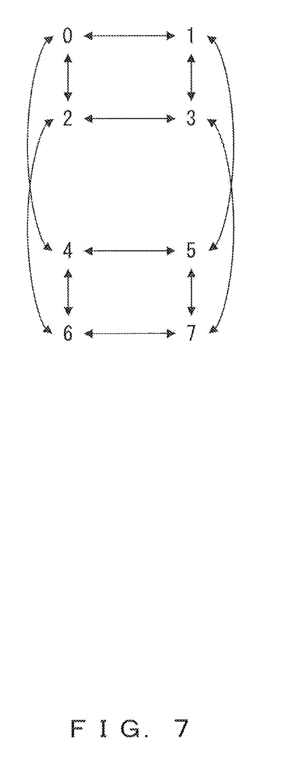

Next, the procedure creation apparatus 12 sequentially picks up two states from among the states registered in the system state table 13 and compares the two states. On the basis of a result of the comparison, the procedure creation apparatus 12 extracts an adjacent relationship in which there is one different attribute value from among the attribute values configuring the system state, so as to create a state transition graph (before a set of transition rules is applied) (S2). This will be described by use of FIG. 7.

FIG. 7 illustrates an example of a state transition graph before a set of transition rules is applied according to the embodiments of the present invention. For example, the procedure creation apparatus 12 acquires state 0 and state 1 from the system state table 13, and compares the attribute values of state 0 and the attribute values of state 1. The only difference between the attribute values of state 0 and the attribute values of state 1 is in the attribute value of an APP server 02 (“VERSION OF APP SERVER 02”), which corresponds to an adjacent relationship in which there is one different attribute value. Then, as illustrated in FIG. 7, the procedure creation apparatus 12 associates state 0 with state 1 by a double-headed arrow. The arrow used for this association indicates a transition from one state to another state.

The procedure creation apparatus 12 acquires state 0 and state 2 from the system state table 13, and compares the attribute values of state 0 and the attribute values of state 2. The only difference between the attribute values of state 0 and the attribute values of state 2 is in the attribute value of an APP server 01 (“VERSION OF APP SERVER 01”), which corresponds to an adjacent relationship in which there is one different attribute value. Then, as illustrated in FIG. 7, the procedure creation apparatus 12 associates state 0 with state 2 by a double-headed arrow, so as to create a transition between the states.

The procedure creation apparatus 12 acquires state 0 and state 3 from the system state table 13, and compares the attribute values of state 0 and the attribute values of state 3. The differences between the attribute values of state 0 and the attribute values of state 3 are in the attribute value of an APP server 01 (“VERSION OF APP SERVER 01”) and the attribute value of an APP server 02 (“VERSION OF APP SERVER 02”), which does not correspond to an adjacent relationship in which there is one different attribute value. In this case, as illustrated in FIG. 7, the procedure creation apparatus 12 does not associate state 0 with state 3 by a double-headed arrow.

This process of determining an adjacent relationship is performed on all the combinations of two states from among the states registered in the system state table 13. This permits obtaining of the state transition graph of FIG. 7. Now return to the description of FIG. 4.

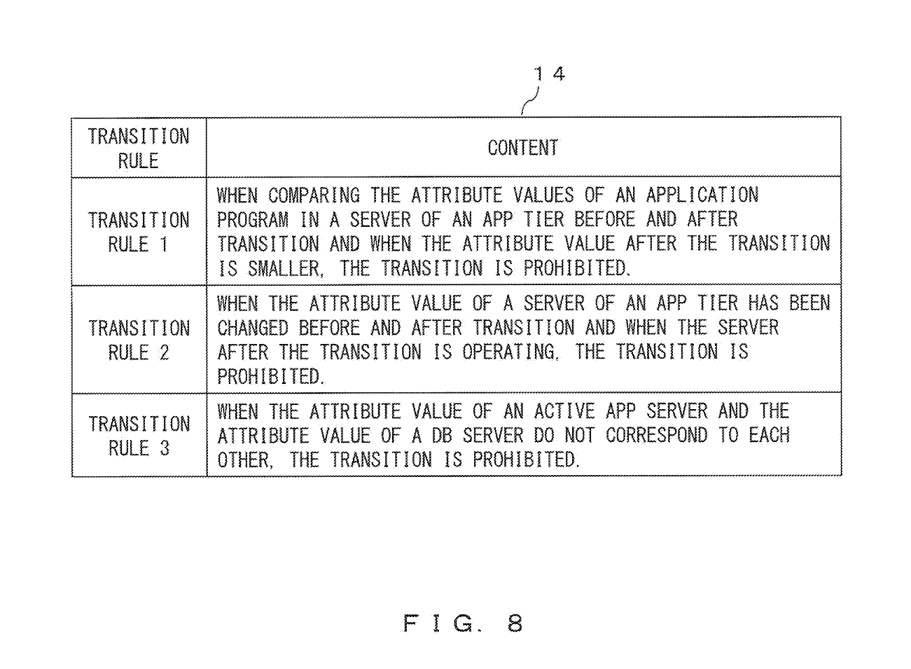

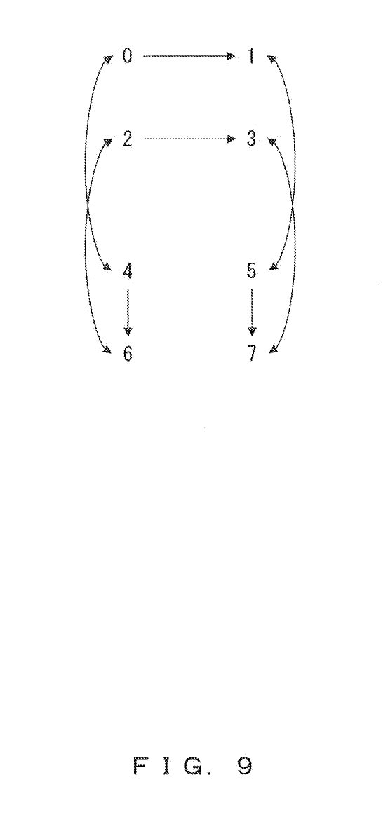

Next, the procedure creation apparatus creates a state transition graph (after the set of transition rules is applied) of FIG. 9 by leaving, from among the transitions (arrows) in the state transition graph of FIG. 7, only the transitions that satisfy a set of transition rules 14 illustrated in FIG. 8 (S3).

FIG. 8 is a table that illustrates an example of a set of transition rules according the embodiments of the present invention. Transition rule 1 specifies that, when comparing the attribute values of an application in a server of an APP tier before and after transition and when the attribute value after the transition is smaller, the transition is prohibited. The servers of an APP tier include a web server and an APP server that are devices other than an LB and a DB server.

Transition rule 2 specifies that, when the attribute value of a server of an APP tier has been changed before and after transition and when the server after the transition is operating, the transition is prohibited.

Transition rule 3 specifies that, when the attribute value of an active APP server and the attribute value of a DB server do not correspond to each other, the transition is prohibited.

FIG. 9 illustrates a state transition graph when the set of transition rules is applied to the state transition graph of FIG. 7. With respect to each of the transitions (arrows) in the state transition graph of FIG. 7, the procedure creation apparatus 12 determines and excludes a prohibited transition according to transition rules 1 to 3.

For example, when the transition from state 1 to state 0 is performed, the version of an APP server 02 is downgraded. In this case, the procedure creation apparatus 12 deletes the transition from the state transition graph of FIG. 7 on the basis of transition rule 1.

Further, for example, when the transition from state 4 to state 5 is performed, the attribute value of an APP server 02 has been changed before and after the transition, and the APP server 02 after the transition is operating. In this case, the procedure creation apparatus 12 deletes the transition from the state transition graph of FIG. 7 on the basis of transition rule 2.

In this way, the state transition graph of FIG. 9 is obtained by applying the set of transition rules 14 of FIG. 8 to the state transition graph of FIG. 7. Now return to the description of FIG. 4.

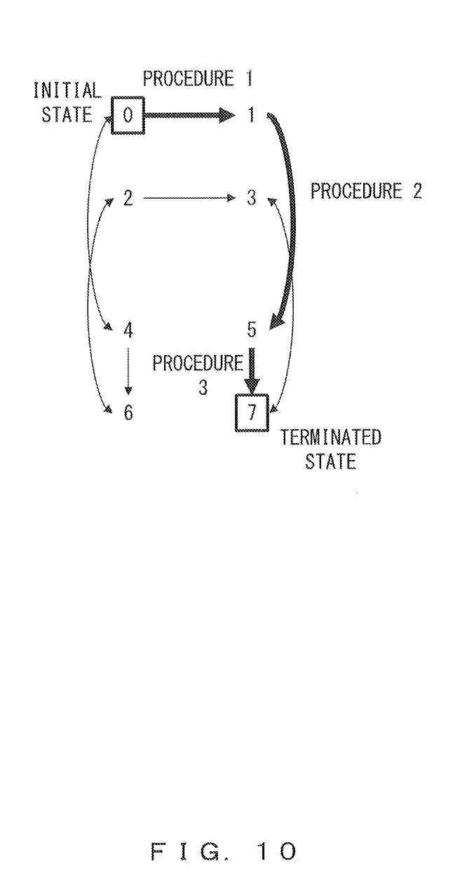

Next, as illustrated in FIG. 10, the procedure creation apparatus 12 searches for the shortest transition route from an initial state to a terminated state in a state transition graph to which the set of transition rules 14 is applied, and associates each transition with a procedure (S4).

FIG. 10 illustrates searching for the shortest transition route from an initial state to a terminated state in a state transition graph to which a set of transition rules is applied and associating each transition with a procedure, according to the embodiments of the present invention. As described in FIG. 6, the initial state is state 0, and the terminated state is state 7. In this case, as illustrated in FIG. 10, the shortest transition route is “state 0→state 1→state 5→state 7”.

The procedure creation apparatus 12 associates a transition “state 0→state 1” with procedure 1, a transition “state 1→state 5” with procedure 2, and a transition “state 5→state 7” with procedure 3.

According to the embodiments, a non-disruptive migration procedure can be automatically created in a multiplex system of a combination of an LB, a web server, an APP server, and a DB server, using transition rules in which the conditions for non-disruption are formalized.

Further, when there are a plurality of procedures for non-disruption, a shortest procedure can be output. For example, when the initial state=0 and the terminated state=7 are provided, as illustrated in FIG. 6, to search for a shortest route, a transition list with “state 0→state 1→state 5→state 7” (three steps) can be obtained, as illustrated in FIG. 10. Furthermore, as seen in FIG. 10, “state 0→state 4→state 6→state 2→state 3→state 7” (five steps) is possible as a non-shortest transition list.

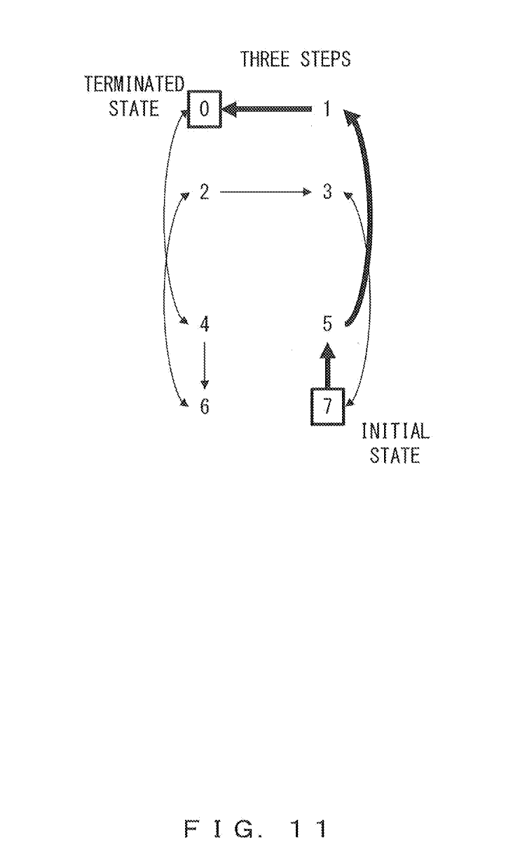

When transition rule 1 “downgrading is prohibited” is replaced with “upgrading is prohibited”, a procedure for non-disruptive downgrade can be created, as illustrated in FIG. 11.

FIG. 11 illustrates a procedure creation when transition rule 1 “downgrading is prohibited” is replaced with “upgrading is prohibited” according to the embodiments of the present invention. In this case, a procedure with three steps “initial state 7→state 5→state 1→terminated state 0” is created.

Next, examples of the embodiments of the present invention will be described in detail.

### First Embodiment

FIG. 12 is a block diagram that illustrates a cloud system and a user terminal according to a first embodiment of the present invention. In FIG. 12, a cloud system 21 and a user terminal 26 are connected via a communication network. The cloud system 21 is configured by ICT (information and communication technology) resources. The cloud system 21 includes a procedure creation apparatus 22, a cloud management mechanism 23, and a target system 25.

The target system 25 includes, for example, an LB, a web server, an APP server, and a DB server, and performs a system migration non-disruptively. In the first embodiment, the system configuration A described in FIG. 2 is used as the target system 25 for convenience of description.

The cloud management mechanism 23 includes, for example, a management server that manages the target system 25. A storage 24 in the cloud management mechanism 23 stores therein device connection information 31, device list information 32, and initial state information 33.

The device connection information 31 is information that represents a connection relationship between devices included in the target system 25. The device list information 32 is list information on devices that are included in the target system 25. The initial state information 33 is information on a set value (attribute value) presently set to a device (an LB, a web server, an APP server, or a DB server) included in the target system 25, that is, an initial state.

When performing a migration on the target system 25, the procedure creation apparatus 22 is an information processing apparatus that creates a migration procedure. The procedure creation apparatus 22 may be placed outside the cloud system 21.

The user terminal 26 is an information processing terminal that is operated by a user when migration is performed on the target system 25.

The cloud management mechanism 23 acquires, from the target system 25, a set value presently set to a device included in the target system 25 and stores it in the storage 24 as initial state information 33 (S11).

When creating an operational procedure for performing migration on the target system 25, a user refers to the device connection information 31, the device list information 32, and the initial state information 33 stored in the storage 24 in the cloud management mechanism 23 as needed, using the user terminal 26 (S12). The user creates terminated state information 34 using the device connection information 31, the device list information 32, and the initial state information 33 that were referred to as needed when creating the operational procedure. The terminated state information 34 is information on a set value of each device included in the target system 25 after migration. Using the user terminal 26, the user transmits, to the procedure creation apparatus 22, an operational procedure creation request that includes the terminated state information 34 (S13).

When receiving the operational procedure creation request, the procedure creation apparatus 22 creates a state transition graph 37 using the device connection information 31, the device list information 32, the initial state information 33, and the terminated state information 34 (S14).

The procedure creation apparatus 22 searches in the state transition graph 37 for the shortest route for the transition from an initial state to a terminated state, and creates a transition list 38 (S15).

The procedure creation apparatus 22 creates a procedure list 39 in which each transition is associated with an operational procedure, using the transition list 38 (S16). The procedure creation apparatus 22 responds to the user terminal 26 with the created procedure list 39 (S17).

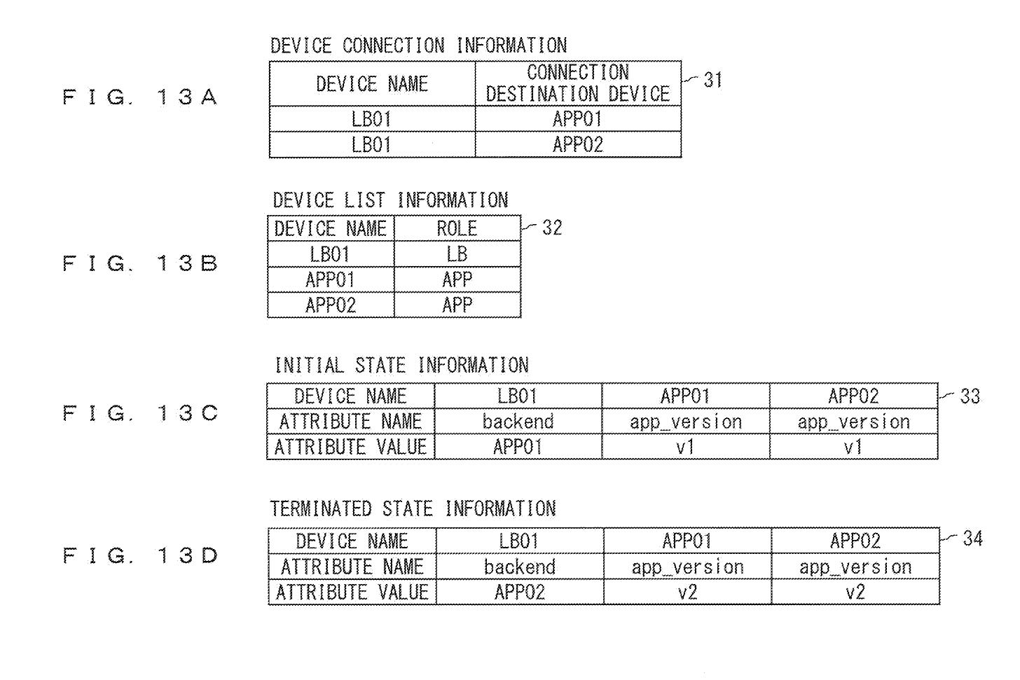

FIGS. 13A to 13D illustrate examples of pieces of information managed by a cloud management mechanism and an example of information transmitted from the user terminal according to the first embodiment.

FIG. 13A illustrates an example of device connection information 31. The device connection information 31 is information that holds a device name and a name of a connection destination device of a device represented by the device name, in association with each other.

FIG. 13B illustrates an example of device list information 32. The device list information 32 is information that holds a device name and a role or function of a device represented by the device name, in associated with each other.

FIG. 13C illustrates an example of initial state information 33. The initial state information 33 is information that holds a name of a device included in the target system 25 before migration, an attribute name of the device, and an attribute value corresponding to the attribute name, in association with one another.

FIG. 13D illustrates an example of terminated state information 34. The terminated state information 34 is information that holds a name of a device included in the target system 25 after migration, an attribute name of the device, and an attribute value corresponding to the attribute name, in association with one another.

The attribute of an LB is represented by the name of a subsequent server that is its transfer destination, and may be omitted when there is no change in the attribute of the LB.

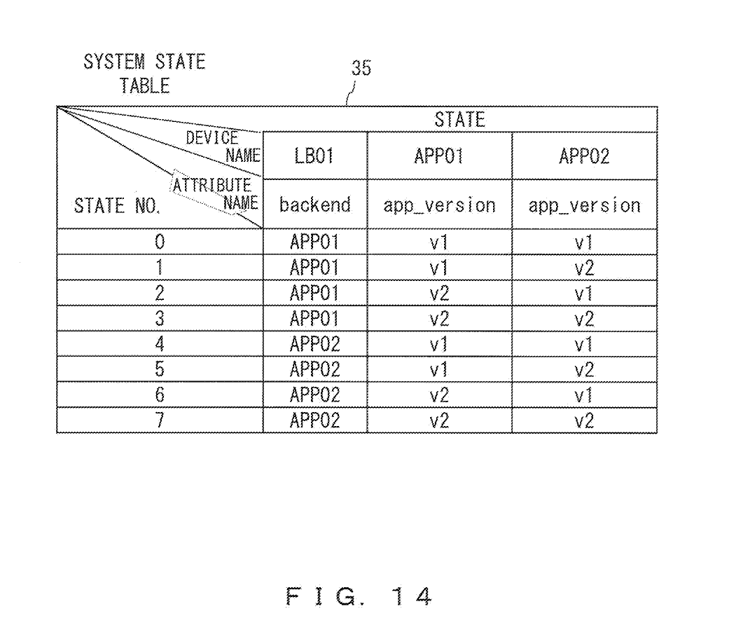

FIG. 14 illustrates an example of a system state table according to the first embodiment. A system state table 35 represents a combination of attribute values of states from an initial state to a terminated state of each device included in the target system 25 in the process of migration. The procedure creation apparatus 22 creates the system state table 35 using the device connection information 31, the device list information 32, the initial state information 33, and the terminated state information 34. The contents of the system state table 35 are similar to those of FIG. 6, so the description will be omitted.

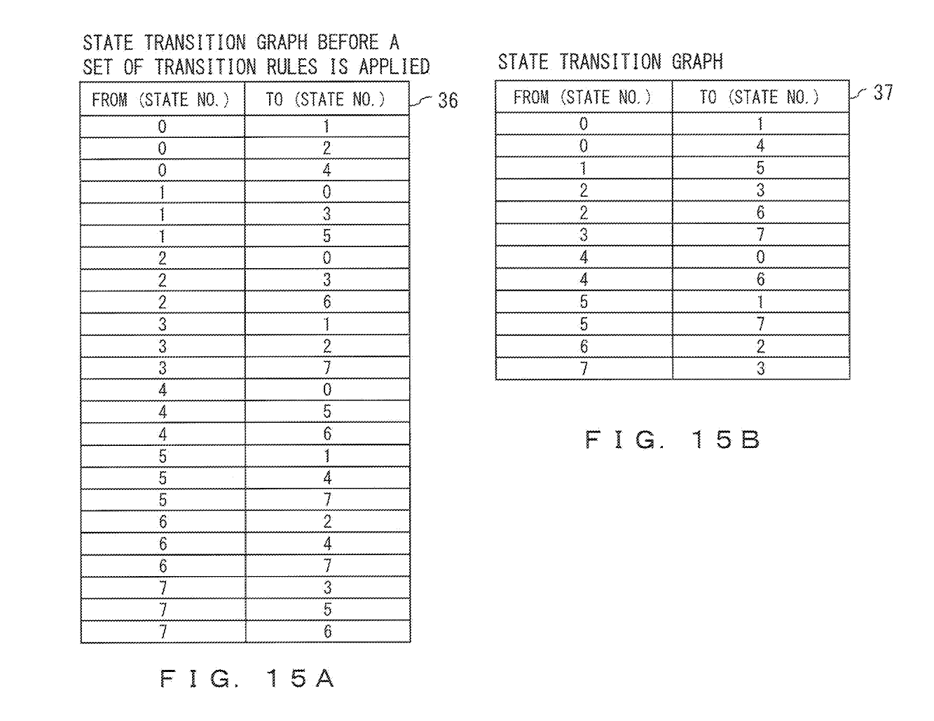

FIGS. 15A and 15B illustrate examples of state transition graphs before and after a set of transition rules is applied according to the first embodiment. A state transition graph 36 before a set of transition rules is applied is transition information that is created by sequentially picking up two states from among the states registered in the system state table 35, by comparing the two states, and by extracting, as a result of the comparison, an adjacent relationship in which there is one different attribute value from among the corresponding attribute values. The state transition graph 36 corresponds to the state transition graph of FIG. 7.

The state transition graph 37 is transition information obtained by excluding a transition prohibited by the set of rules from the state transition graph 36 before a set of transition rules is applied. The state transition graph 37 corresponds to the state transition graph of FIG. 9.

Both state transition graphs 36 and 37 hold a state No. before transition and a state No. after transition in pairs.

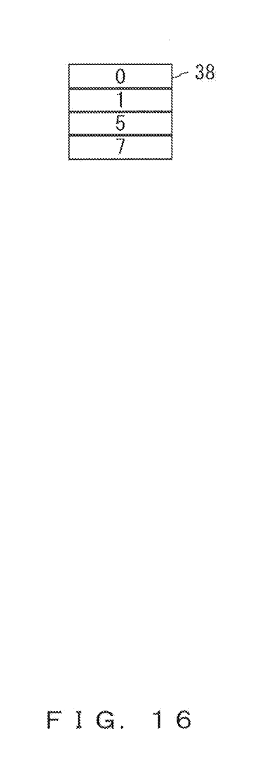

FIG. 16 illustrates an example of a transition list according to the first embodiment. In a transition list 38, state numbers are registered in the order of the state to transition.

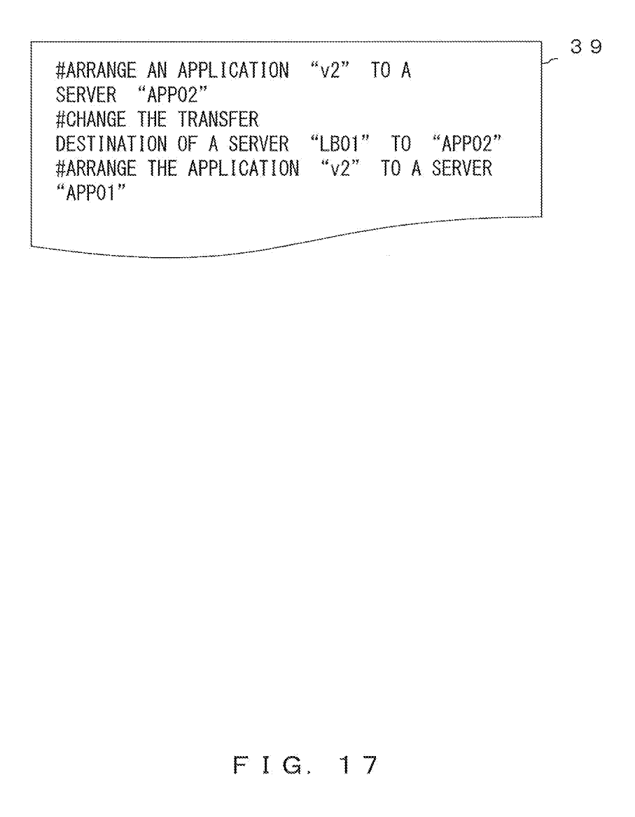

FIG. 17 illustrates an example of a procedure list according the first embodiment. An operational procedure when transitioning between states in the order of the states registered in the transition list 38 has been output to a procedure list 39.

Next, the processes of S14 to S17 performed by the procedure creation apparatus 22 will be described in detail with reference to FIGS. 18 to 23.

FIGS. 18A and 18B are a flowchart for creating a state transition graph according to the first embodiment. In the first embodiment, the attribute of an LB can be omitted in terminated state information 34 when there is no change in the attribute of the LB.

When creating the system state table 35 using the device connection information 31, the device list information 32, the initial state information 33, and the terminated state information 34, first, the procedure creation apparatus 22 performs the following process. The procedure creation apparatus 22 determines whether the attribute value of an LB is included in the terminated state information 34, that is, whether the number of devices in the terminated state information 34 is smaller than that in the initial state information 33 (S14-1). When the attribute value of an LB is included in the terminated state information 34 (“NO” in S14-1), the process moves on to S14-4.

When the attribute value of an LB is not included in the terminated state information 34, that is, when the number of devices in the terminated state information 34 is smaller than that in the initial state information 33 (“YES” in S14-1), the procedure creation apparatus 22 performs the following process. The procedure creation apparatus 22 determines, on the basis of the device list information 32, whether the role of an omitted device is an LB (S14-2). When the role of the omitted device is not an LB (“NO” in S14-2), this flow ends.

When the role of the omitted device is an LB (“YES” in S14-2), the procedure creation apparatus 22 identifies all the servers that are connected to the LB using the device connection information 31. The procedure creation apparatus 22 acquires the names of the identified servers as possible values of the device that serves as an LB (S14-3).

The procedure creation apparatus 22 outputs, to the system state table 35, all the combinations of possible attribute values (system state information) for each device included in the initial state information 33 and the terminated state information 34 (S14-4).

The procedure creation apparatus 22 selects two states from the system state table 35 and compares corresponding attributes. When there is one different attribute value, the procedure creation apparatus 22 determines that the states have an adjacent relationship and registers in the state transition graph 36 before a set of transition rules is applied (S14-5). The process of S14-5 is performed on all the combinations.

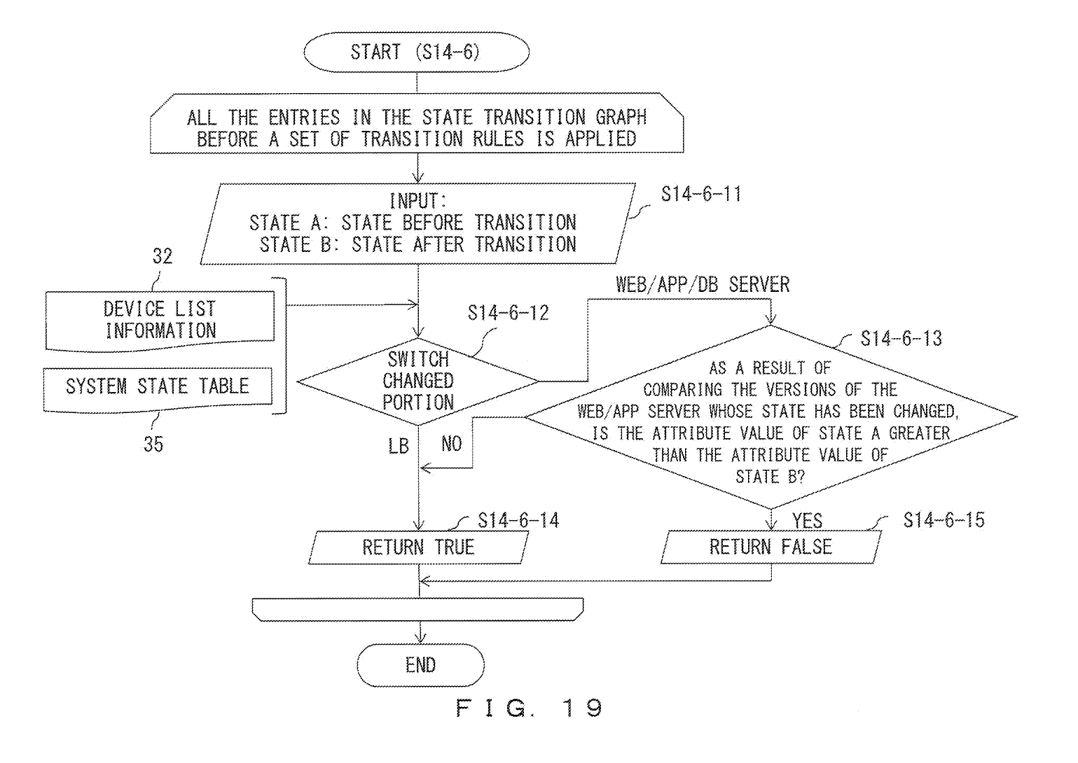

Next, the procedure creation apparatus 22 performs a non-disruption-procedure determination process (s14-6). The procedure creation apparatus 22 determines whether each state transition included in the state transition graph 36 before a set of transition rules is applied satisfies transition rules 1 to 3. In this case, transition rules 1 to 3 are similar to the rules described in FIG. 8. The procedure creation apparatus 22 excludes, from the state transition graph 36 before a set of transition rules is applied, a state transition that does not satisfy transition rules 1, 2, or 3. The process of S14-6 will be described in detail with reference to FIGS. 19 to 21.

FIG. 19 is a flowchart that illustrates a process of determining (S14-6) whether each state transition included in a state transition graph before a set of transition rules satisfies transition rule 1 according to the first embodiment. A non-disruption-procedure determination process by use of transition rule 1 returns false if a transition between two states in the state transition graph 36 before a set of transition rules is applied is a downgrading of a program and otherwise returns true.

First, the procedure creation apparatus 22 reads one entry (state transition) from the state transition graph 36 before a set of transition rules is applied. Here, the state before transition is defined as “state A” and the state after transition is defined as “state B” from among the read state transitions (S14-6-11).

By use of the device list information 32 and the system state table 35, the procedure creation apparatus 22 determines which device the read state transition corresponds to (S14-6-12). When the read state transition is a state transition of an LB, the procedure creation apparatus 22 returns “true” (S14-6-14).

When the read state transition is a state transition of a web server, an APP server, or a DB server, the procedure creation apparatus 22 compares the versions of the web server, the APP server, or the DB server whose state has been changed. As a result of the comparison, the procedure creation apparatus 22 determines whether the attribute value of state A is greater than the attribute value of state B (S14-6-13).

When the attribute value of state A is greater than the attribute value of state B (“YES” in S14-6-13), the procedure creation apparatus 22 returns “false” (S14-6-15). On the other hand, when the attribute value of state A is not greater than the attribute value of state B (“NO” in S14-6-13), the procedure creation apparatus 22 returns “true” (S14-6-14).

The process of this flowchart is repeated for all the entries in the state transition graph 36 before a set of transition rules is applied.

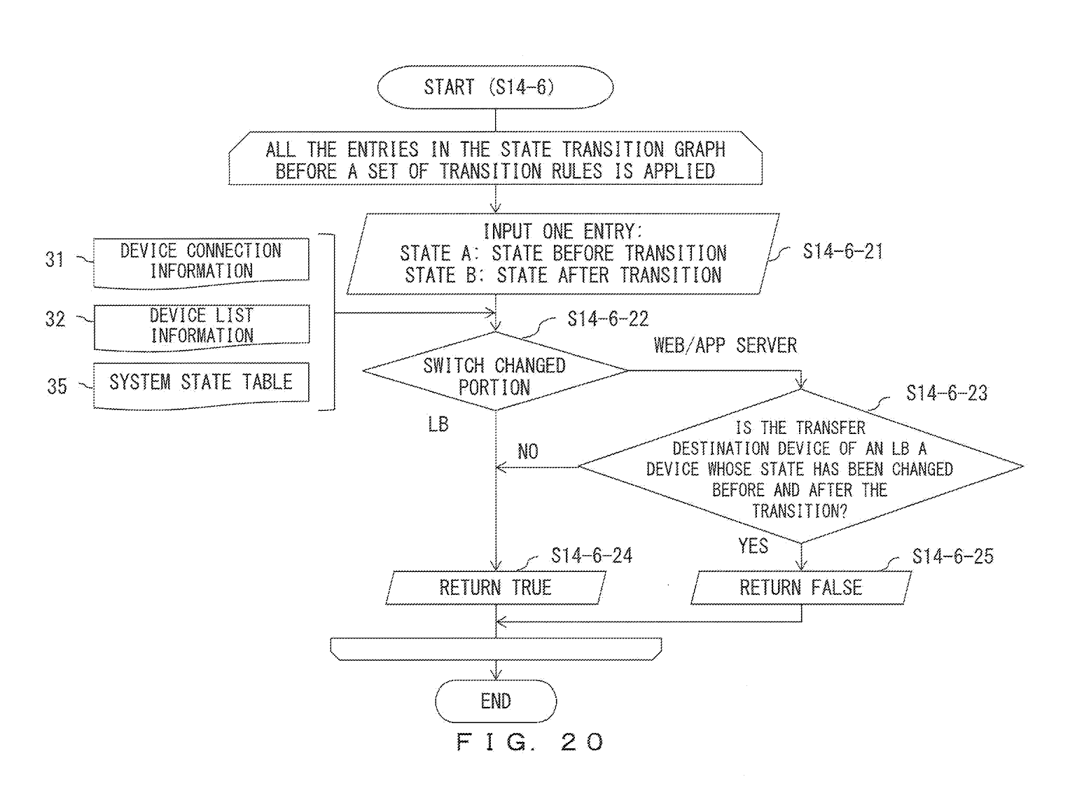

FIG. 20 is a flowchart that illustrates a process of determining (S14-6) whether each state transition included in a state transition graph before a set of transition rules satisfies transition rule 2 according to the first embodiment. A non-disruption-procedure determination process by use of transition rule 2 returns false if there is a change in the state of a transfer destination server of an LB during a transition between states and otherwise returns true.

First, the procedure creation apparatus 22 reads one entry (state transition (the state before transition: state A, and the state after transition: state B)) from the state transition graph 36 before a set of transition rules is applied (S14-6-21).

By use of the device connection information 31, the device list information 32, and the system state table 35, the procedure creation apparatus 22 determines which device the read state transition corresponds to (S14-6-22). When the read state transition is a state transition of an LB, the procedure creation apparatus 22 returns “true” (S14-6-24).

When the read state transition is a state transition of a web server or an APP server, the procedure creation apparatus 22 determines whether the transfer destination device of an LB is a device whose state has been changed before and after the transition (S14-6-23).

When the transfer destination device of an LB is a device whose state has been changed before and after the transition (“YES” in S14-6-23), the procedure creation apparatus 22 returns “false” (S14-6-25). On the other hand, when the transfer destination device of an LB is not a device whose state has been changed before and after the transition (“NO” in S14-6-23), the procedure creation apparatus 22 returns “true” (S14-6-24).

The process of this flowchart is repeated for all the entries in the state transition graph 36 before a set of transition rules is applied.

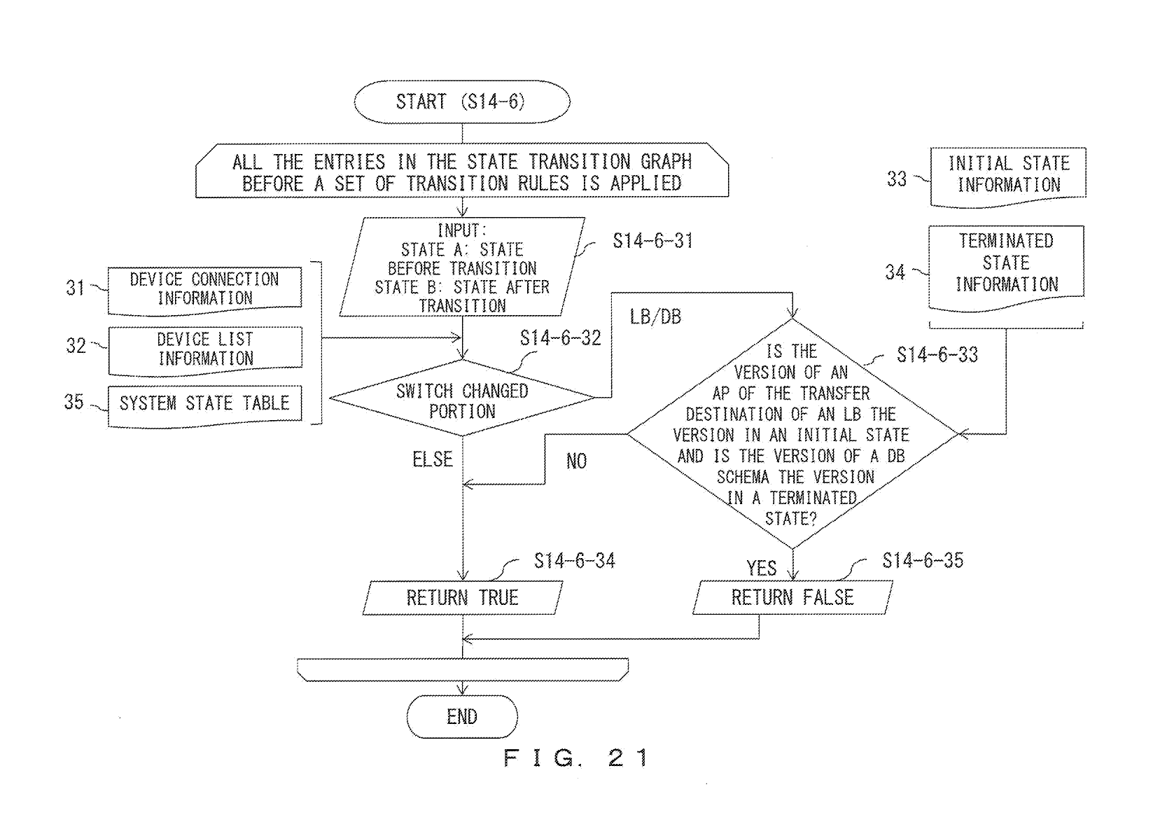

FIG. 21 is a flowchart that illustrates a process of determining (S14-6) whether each state transition included in a state transition graph before a set of transition rules satisfies transition rule 3 according to the first embodiment. A non-disruption-procedure determination process by use of transition rule 3 returns “false” if the version of an application of the transfer destination of an LB and the version of a DB schema after transition are a combination of an “old version of APP” and a “new version of DB” and otherwise returns “true”.

First, the procedure creation apparatus 22 reads one entry (state transition (the state before transition: state A, and the state after transition: state B)) from the state transition graph 36 before a set of transition rules is applied (S14-6-31).

By use of the device connection information 31, the device list information 32, and the system state table 35, the procedure creation apparatus 22 determines which device the read state transition corresponds to (S14-6-32). When the read state transition is a state transition of a device other than an LB and a DB server, the procedure creation apparatus 22 returns “true” (S14-6-34).

When the read state transition is a state transition of an LB or a DB server, the procedure creation apparatus 22 performs the following process. The procedure creation apparatus 22 determines whether the version of an application of the transfer destination device of an LB is a version in an initial state and the version of a DB schema is a version in a terminated state after the transition, on the basis of the initial state information 33 and terminated state information 34 (S14-6-33).

When the version of an application of the transfer destination device of an LB is a version in an initial state and the version of a DB schema is a version in a terminated state after the transition (“YES” in S14-6-33), the procedure creation apparatus 22 returns “false” (S14-6-35). On the other hand, when the version of an application of the transfer destination device of an LB is not a version in an initial state after the transition, or the version of a DB schema is not a version in a terminated state after the transition (“NO” in S14-6-33), the procedure creation apparatus 22 returns “true” (S14-6-34).

The process of this flowchart is repeated for all the entries in the state transition graph 36 before a set of transition rules is applied.

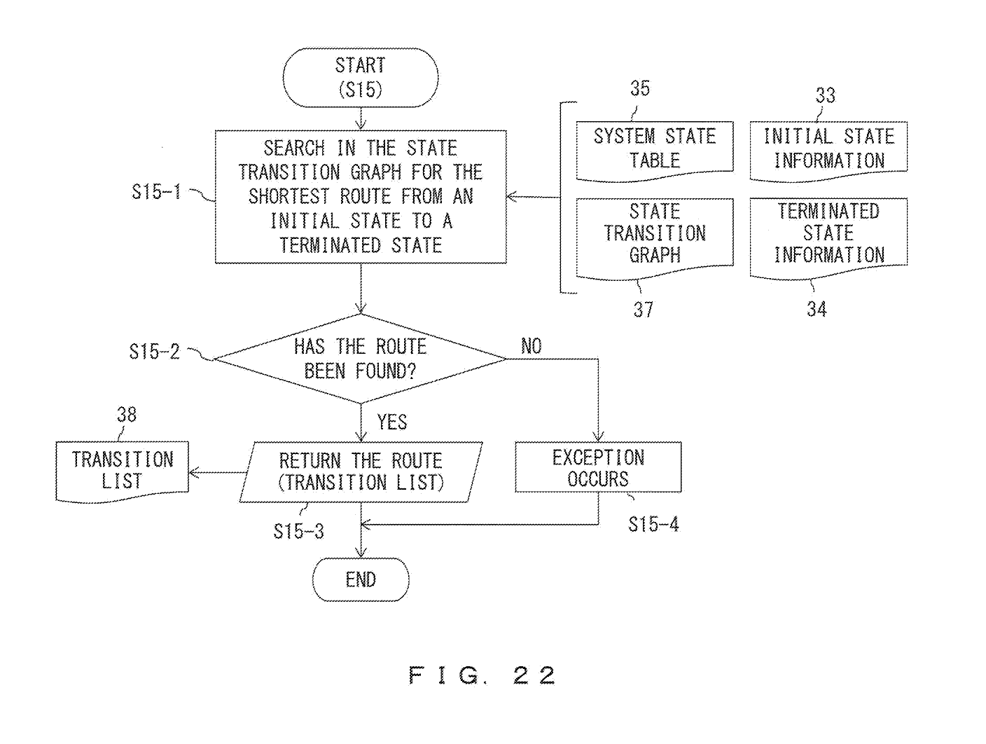

FIG. 22 is a flowchart that illustrates in detail a process of searching for a graph route (S15) according to the first embodiment. The procedure creation apparatus 22 searches in the state transition graph 37 the shortest route from an initial state to a terminated state using the initial state information 33, the terminated state information 34, the system state table 35, and the state transition graph 37 (S15-1). For example, an algorithm such as Dijkstra's algorithm may be used for the process of searching the shortest route.

When the shortest route has been found (“YES” in S15-2), the procedure creation apparatus 22 outputs the found route as a transition list 38 (S15-3). When the shortest route has not been found (“NO” in S15-2), an exceptional process occurs (S15-4).

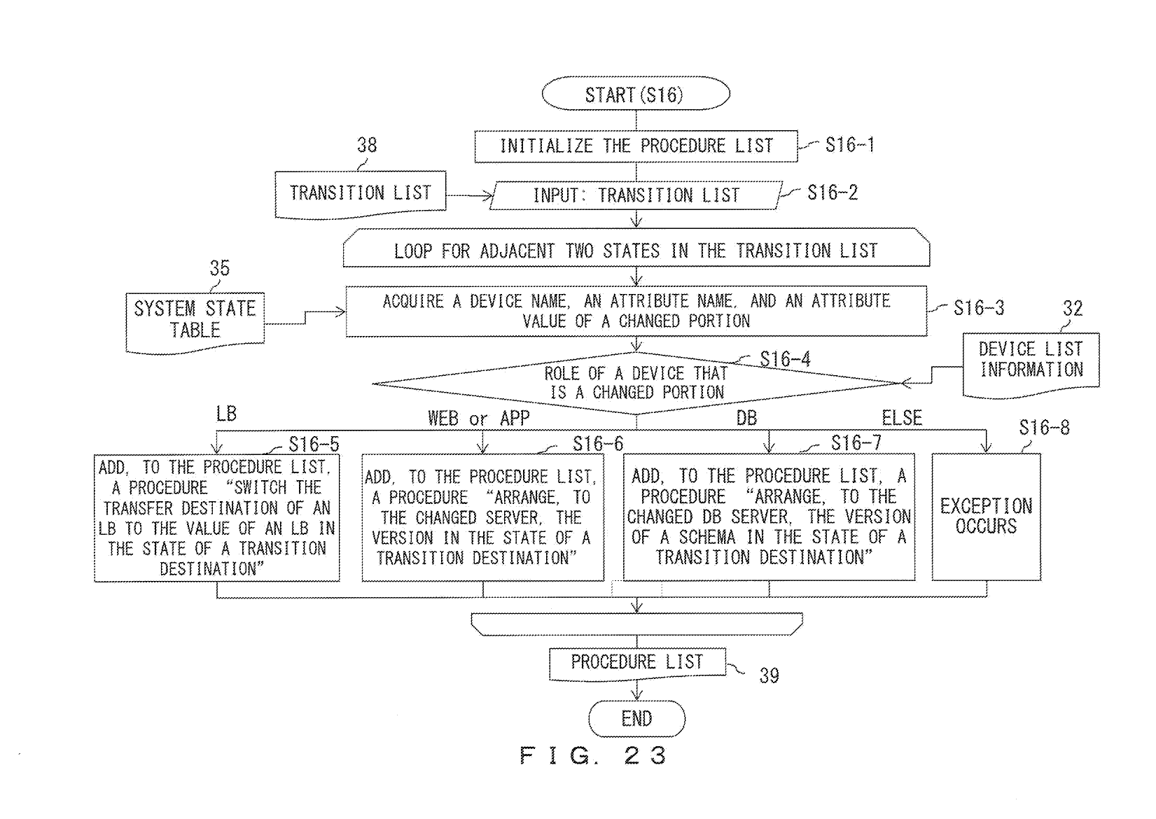

FIG. 23 is a flowchart that illustrates in detail a process of associating (S16) each transition with a procedure according to the first embodiment. In the flow of FIG. 23, the procedure creation apparatus 22 associates each transition in the transition list 38 with the following procedure as follows. The transition in which the set value of an LB is changed is associated with a procedure in which the transfer destination of the LB is changed to a designated server. The transition in which the set value of a web, an APP, or a DB is changed is associated with a procedure in which the version of an application or a DB schema is changed to a designated attribute value (the version of the application or the DB schema).

First, the procedure creation apparatus 22 initializes the procedure list 39 (S16-1). The procedure creation apparatus 22 reads the transition list 38 (S16-2).

The procedure creation apparatus 22 reads two states before and after a transition with one step from the transition list 38. The procedure creation apparatus 22 acquires, from the system state table 35, a device name, an attribute name, and an attribute value of a changed portion of the read two states (S16-3).

The procedure creation apparatus 22 determines a role of a device acquired in S16-3, on the basis of the device list information 32 (S16-4).

When the role of the device is an “LB”, the procedure creation apparatus 22 adds, to the procedure list 39, a procedure “switch the transfer destination of an LB to the LB value in the state of a transition destination” (S16-5).

When the role of the device is a “web server” or a “APP server”, the procedure creation apparatus 22 adds, to the procedure list 39, a procedure “arrange, to the changed server, the version in the state of a transition destination” (S16-6).

When the role of the device is a “DB server”, the procedure creation apparatus 22 adds, to the procedure list 39, a procedure “arrange, to the changed DB server, the version of a schema in the state of a transition destination” (S16-7).

When the role of the device is not an “LB”, a “web server”, an “APP server”, or a “DB server”, an exceptional process occurs (S16-8).

The procedure creation apparatus 22 repeats the processes of S16-3 to S16-8 for all the steps of the state transitions in the transition list 38, and outputs the procedure list 39.

### Second Embodiment

A second embodiment of the present invention uses the system configuration B of FIG. 2 as a target system.

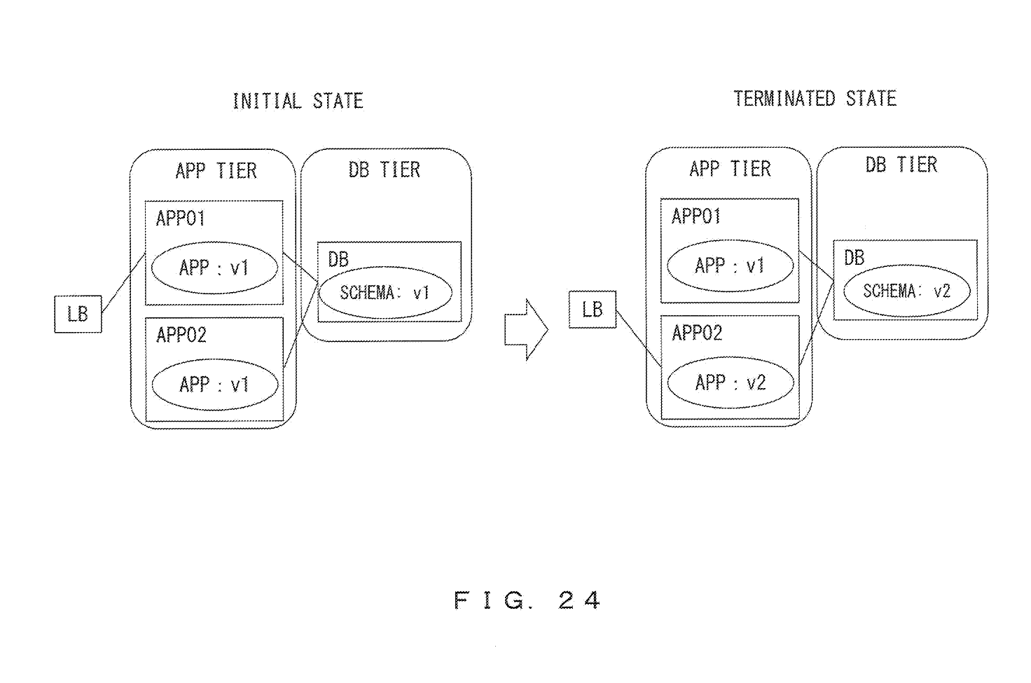

FIG. 24 illustrates an initial state and a terminated state of a target system according to the second embodiment. In the initial state, an active system is an APP01 server (the version of an application: v1) and a DB server (the version of a schema: v1). A standby system is an APP02 server (the version of an application: v1).

In the terminated state, an active system is an APP02 server (the version of an application: v2) and a DB server (the version of a schema: v2). A standby system is an APP01 server (the version of an application: v1).

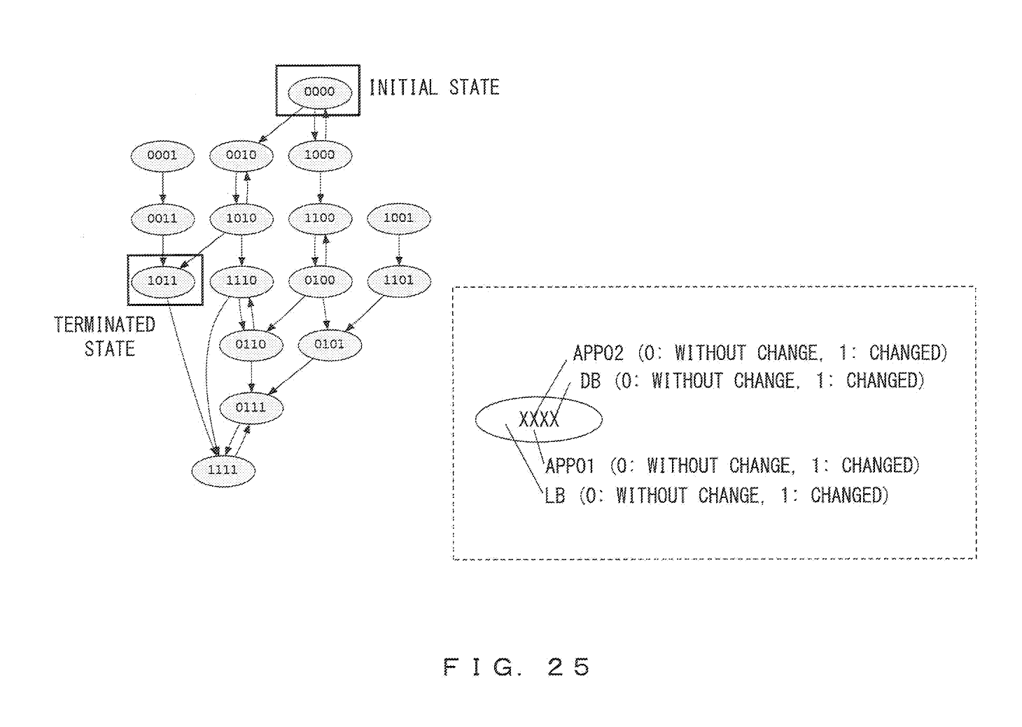

FIG. 25 illustrates a state transition graph according to the second embodiment. Each ellipse in FIG. 25 represents the system state information of FIG. 24. The system state information is represented by a 4-digit bit value. In the 4-digit bit value, the numbers represent, from the left, the state of an LB, the state of an APP01, the state of an APP02, and the state of a DB, respectively. “0” indicates that there is no change in the state of the device. “1” indicates that there is a change in the state of the device.

When the system configuration is as described in FIG. 24, the state transition graph of FIG. 25, a state transition route with three hops that is the shortest route from an initial state to a terminated state, and a non-disruptive migration procedure are obtained using transition rules 1 to 3. The state transition route with three hops is a route “0000”→“0010”→“1010”→“1011”.

### Third Embodiment

A third embodiment of the present invention uses the system configuration C of FIG. 2 as a target system.

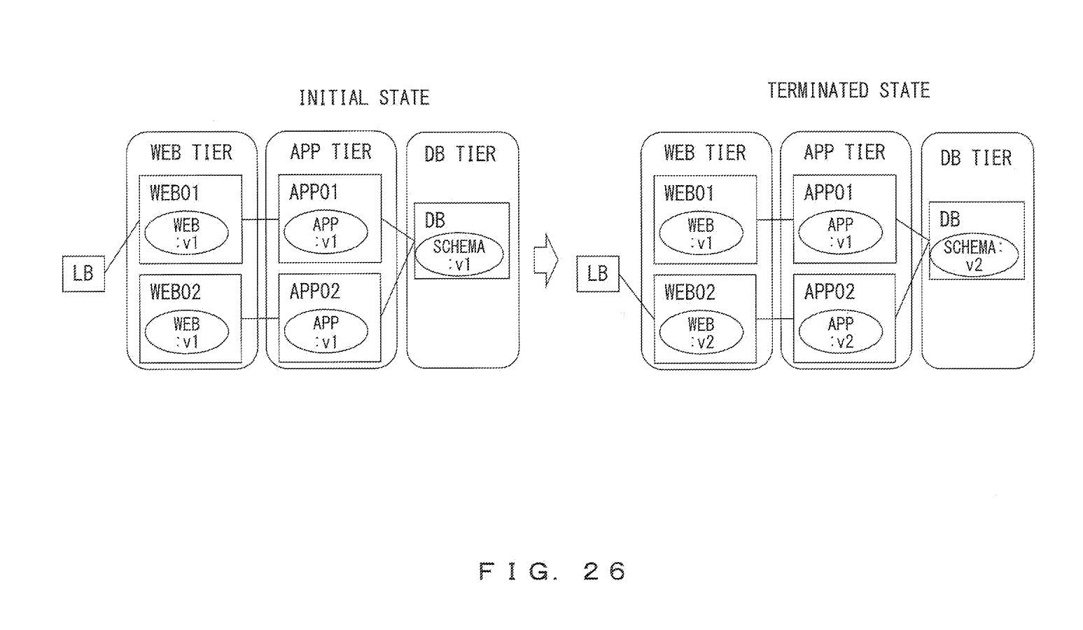

FIG. 26 illustrates an initial state and a terminated state of a target system according to the third embodiment. In the initial state, an active system is a web01 server (the version of an application: v1), an APP01 server (the version of an application: v1), and a DB server (the version of a schema: v1). A standby system is a web02 server (the version of an application: v1) and an APP02 server (the version of an application: v1).

In the terminated state, an active system is a web02 server (the version of an application: v2), an APP02 server (the version of an application: v2), and a DB server (the version of a schema: v2). A standby system is a web01 server (the version of an application: v1) and an APP01 server (the version of an application: v1).

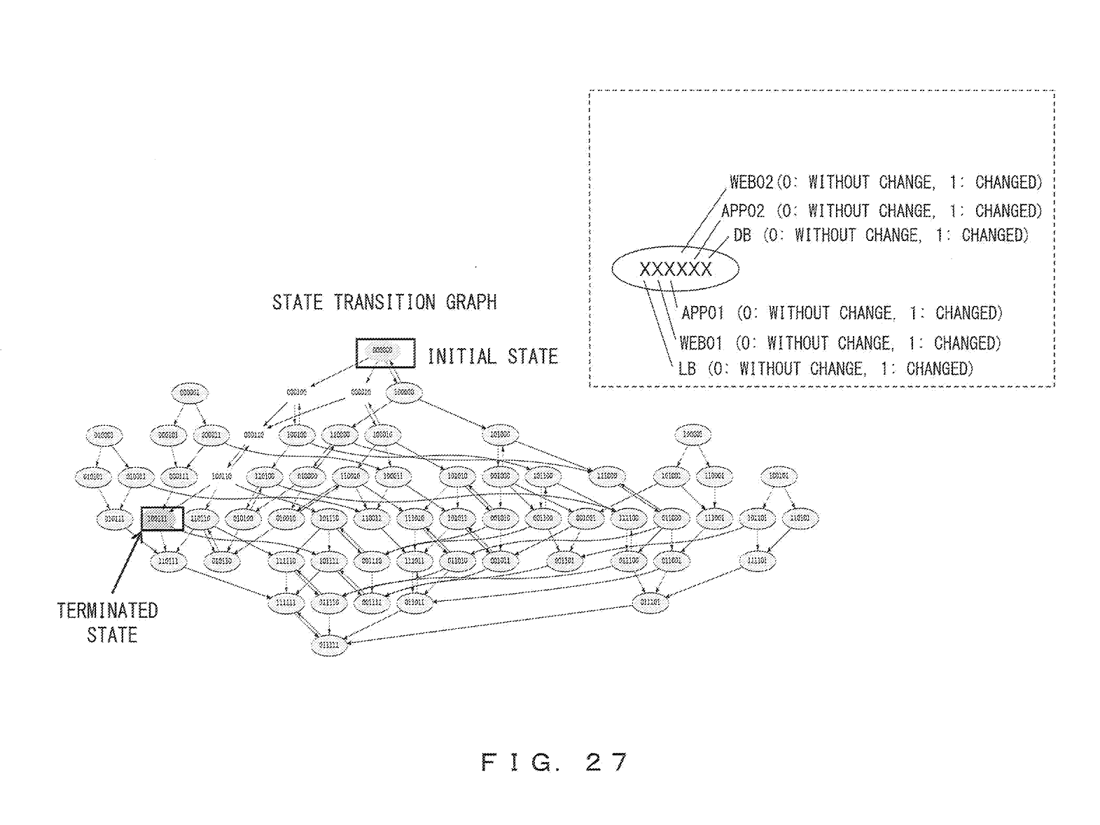

FIG. 27 illustrates a state transition graph according to the third embodiment. Each ellipse in FIG. 27 represents the system state information of FIG. 26. The system state information is represented by a 6-digit bit value. In the 6-digit bit value, the numbers represent, from the left, the state of an LB, the state of a web01, the state of an APP01, the state of a web02, the state of an APP02, and the state of a DB, respectively. “0” indicates that there is no change in the state of the device. “1” indicates that there is a change in the state of the device.

When the system configuration is as described in FIG. 26, the state transition graph of FIG. 25, a state transition route with four hops that is the shortest route from an initial state to a terminated state, and a non-disruptive migration procedure are obtained using transition rules 1 to 3. The state transition route with four hops is a route “000000”→“000010”→“000110”→“100110”→“100111”, or “000000”→“000100”→“000110”→“100110”→“100111”. As described above, there may be a plurality of state transitions having the same number of hops. In the third embodiment, (a procedure corresponding to) the state transition that reaches a terminated state first is returned. However, both routes satisfy the sets of transition rules, so it does not matter which route is selected. In this example, the difference is merely in the order, that is, web→APP or APP→web.

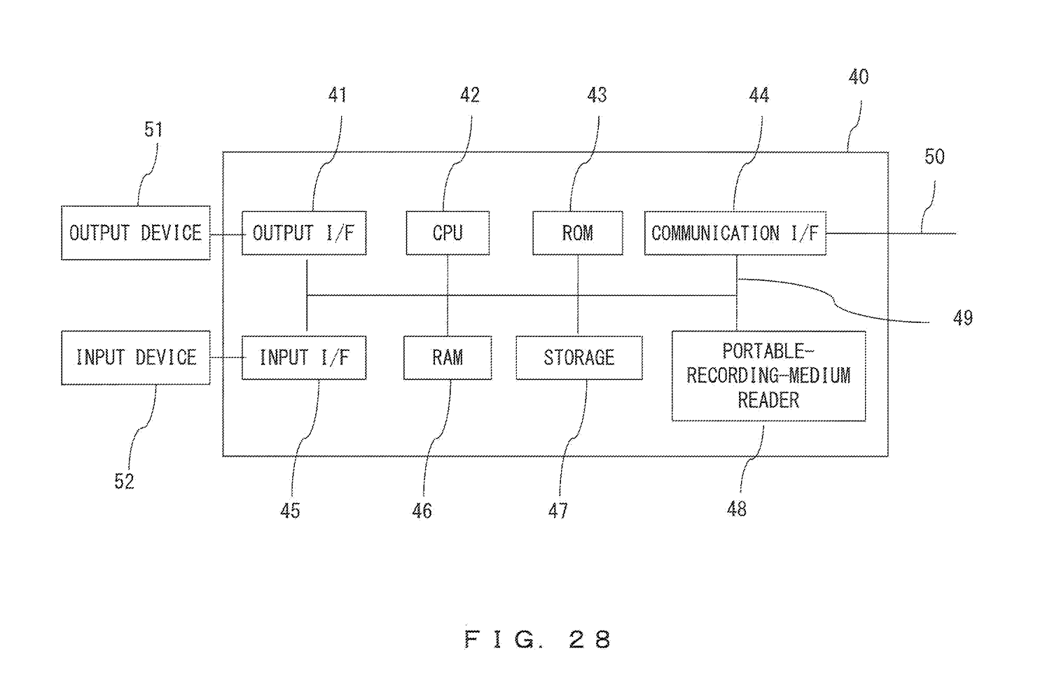

FIG. 28 is a configurative block diagram that illustrates an example of a hardware environment of a computer that executes a program according to the embodiments of the present invention. A computer 40 functions as the procedure creation apparatus 22. The computer 40 includes a CPU 42, a ROM 43, a RAM 46, a communication I/F 44, a storage 47, an output I/F 41, an input I/F 45, a reader 48, a bus 49, an output device 51, and an input device 52.

Here, CPU indicates a central processing unit. ROM indicates a read only memory. RAM indicates a random access memory. I/F indicates an interface. The CPU 42, the ROM 43, the RAM 46, the communication I/F 44, the storage 47, the output I/F 41, the input I/F 45, and the reader 48 are connected to the bus 49. The reader 48 reads a portable recording medium. The output device 51 is connected to the output I/F 41. The input device 52 is connected with to the input I/F 45.

As the storage 47, storages in various forms such as a hard disk, a flash memory, and a magnetic disk can be used. The storage 47 or the ROM 43 stores thereon a program according to the embodiments of the present invention that allows the CPU 42 to function as the acquisition unit 2, the storage unit 3, the creation unit 4, the extraction unit 5, the identification unit 6, and the output unit 7. Further, the storage 47 stores therein, for example, device connection information 31, device list information 32, initial state information 33, terminated state information 34, a system state table 35, state transition graphs 36 and 37, a transition list 38, a procedure list 39, and transition rules 1 to 3 (14). The RAM 46 temporarily stores therein information.

As the procedure creation apparatus 22, the CPU 42 reads the program according to the embodiments of the present invention from the storage 47 or the ROM 43, so as to execute the program.

The program that realizes the processes described in the above embodiments may be stored on, for example, the storage 47 by a provider of the program through a communication network 50 and the communication I/F 44. Further, the program that realizes the processes described in the above embodiments may be stored in a portable recording medium that is commercially available and distributed. In this case, the portable recording medium may be set to the reader 48 so that the program is read and executed by the CPU 42. As a portable recording medium, recording media in various forms such as a CD-ROM, a flexible disk, an optical disk, a magneto-optical disk, an IC card, and a USB memory can be used. The program stored on such a recording medium is read by the reader 48.

Further, for example, a keyboard, a mouse, an electronic camera, a web camera, a microphone, a scanner, a sensor, and a tablet can be used as the input device 52. Furthermore, for example, a display, a printer, and a speaker can be used as the output device 51. Moreover, the network 50 may be communication networks such as the Internet, a LAN, a WAN, an exclusive line, a fixed line, and a wireless.

An aspect of the present invention permits providing of an optimal procedure for controlling an information processing system until the information processing system reaches a changed state when there is a change in the state of the information processing system.

Embodiments of the present invention are not limited to the above mentioned embodiments but are amenable to various configurations or embodiments without departing from the scope of the invention.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A control procedure creation method comprising:
acquiring, by a computer, changed contents of a state of an information processing system including a plurality of devices;
creating, by the computer, by use of state information on the plurality of devices that is stored in a storage and the received changed contents, state information on the information processing system for each state transition on the basis of possible states of each of the plurality of devices during a transition, in accordance with the changed contents, until the information processing system reaches a changed state;
extracting, by the computer, from the created state information on the information processing system for each state transition, a candidate procedure for controlling the plurality of devices until the information processing system reaches the changed state, on the basis of a set of state transition rules stored in the storage; and
identifying, by the computer, from among the candidate control procedures, a control procedure that includes the fewest steps.

2. The control procedure creation method according to claim 1, wherein
the creating acquires two pieces of state information from the state information on the information processing system, compares attribute values that are included in the pieces of state information and whose attributes correspond to each other, and, as a result of the comparison, associates, as state information before and after transition, pieces of state information in pairs that have one different attribute value.

3. The control procedure creation method according to claim 2, wherein
the set of state transition rules includes a transition rule that prohibits, from among transitions between associated two pieces of state information, a transition in which a program is downgraded, a transition rule that prohibits, from among the transitions between associated two pieces of state information, a transition when a device whose state has been changed is operating, and a transition rule that prohibits, from among the transitions between associated two pieces of state information, a transition when the change in state occurs in a combination of certain versions of programs for which an operation has not been verified between the plurality of devices.

4. The control procedure creation method according to claim 1, further comprising:
outputting, by use of control contents of each of the plurality of devices when a state has been changed, the control contents being stored in the storage, control procedure information in which each step included in the identified control procedure is associated with control contents of a device corresponding to each of the steps.

5. A non-transitory computer-readable recording medium having stored therein a control procedure creation program for causing a computer to execute a process comprising:
acquiring changed contents of a state of an information processing system including a plurality of devices;
creating, by use of state information on the plurality of devices that is stored in a storage and the received changed contents, state information on the information processing system for each state transition on the basis of possible states of each of the plurality of devices during a transition, in accordance with the changed contents, until the information processing system reaches a changed state;
extracting, from the created state information on the information processing system for each state transition, a candidate procedure for controlling the plurality of devices until the information processing system reaches the changed state, on the basis of a set of state transition rules stored in the storage; and
identifying, from among the candidate control procedures, a control procedure that includes the fewest steps.

6. The non-transitory computer-readable recording medium according to claim 5, wherein
the creating acquires two pieces of state information from the state information on the information processing system, compares attribute values that are included in the pieces of state information and whose attributes correspond to each other, and, as a result of the comparison, associates, as state information before and after transition, pieces of state information in pairs that have one different attribute value.

7. The non-transitory computer-readable recording medium according to claim 6, wherein
the set of state transition rules includes a transition rule that prohibits, from among transitions between associated two pieces of state information, a transition in which a program is downgraded, a transition rule that prohibits, from among the transitions between associated two pieces of state information, a transition when a device whose state has been changed is operating, and a transition rule that prohibits, from among the transitions between associated two pieces of state information, a transition when the change in state occurs in a combination of certain versions of programs for which an operation has not been verified between the plurality of devices.

8. The non-transitory computer-readable recording medium according to claim 5, the process further comprising:
outputting, by use of control contents of each of the plurality of devices when a state has been changed, the control contents being stored in the storage, control procedure information in which each step included in the identified control procedure is associated with control contents of a device corresponding to each of the steps.

9. A control procedure creation apparatus comprising:
a storage unit that stores therein state information on a plurality of devices and a set of state transition rules; and
a processor that executes a process including
acquiring changed contents of a state of an information processing system including the plurality of devices,
creating, by use of the state information on the plurality of devices and the received changed contents, state information on the information processing system for each state transition on the basis of possible states of each of the plurality of devices during a transition, in accordance with the changed contents, until the information processing system reaches a changed state,
extracting, from the created state information on the information processing system for each state transition, a candidate procedure for controlling the plurality of devices until the information processing system reaches the changed state, on the basis of the set of state transition rules, and
identifying, from among the candidate control procedures, a control procedure that includes the fewest steps.

10. The control procedure creation apparatus according to claim 9, wherein
the creating acquires two pieces of state information from the state information on the information processing system, compares attribute values that are included in the pieces of state information and whose attributes correspond to each other, and, as a result of the comparison, associates, as state information before and after transition, pieces of state information in pairs that have one different attribute value.

11. The control procedure creation apparatus according to claim 10, wherein
the set of state transition rules includes a transition rule that prohibits, from among transitions between associated two pieces of state information, a transition in which a program is downgraded, a transition rule that prohibits, from among the transitions between associated two pieces of state information, a transition when a device whose state has been changed is operating, and a transition rule that prohibits, from among the transitions between associated two pieces of state information, a transition when the change in state occurs in a combination of certain versions of programs for which an operation has not been verified between the plurality of devices.

12. The control procedure creation apparatus according to claim 9, wherein
the process further includes outputting, by use of control contents of each of the plurality of devices when a state has been changed, the control contents being stored in the storage, control procedure information in which each step included in the identified control procedure is associated with control contents of a device corresponding to each of the steps.
